(19) United States
(12) Patent Application Publication
(10) Pub. No.: US 2023/0391981 A1
(43) Pub. Date: Dec. 7, 2023

(54) METHOD OF PREPARING A HETEROGENEOUS COMPOSITE CHEMICAL CURATIVE DISPERSION FOR MAKING ELASTOMERIC ARTICLE

(71) Applicant: CI TECHNOLOGY SDN BHD, Kuala Lumpur (MY)

(72) Inventor: Kok Ho TEE, Kuala Lumpur (MY)

(73) Assignee: CI TECHNOLOGY SDN BHD, Kuala Lumpur (MY)

(21) Appl. No.: 18/248,425

(22) PCT Filed: Sep. 20, 2021
(86) PCT No.: PCT/MY2021/050077

§ 371 Date: Apr. 10, 2023

(30) Foreign Application Priority Data
Oct. 12, 2020 (MY) PI2020005348

(51) Int. Cl. C08K 3/22; C08L 9/04

(52) U.S. Cl. CPC C08K 3/22; C08L 9/04; C08K 2003/2203

(57) ABSTRACT

The present invention relates to method of preparing a heterogeneous composite chemical curative dispersion with high reactivity and less chemicals consumption for making elastomeric article. Said method comprising the steps of: preparing a metal composite; adding alkaline solution in said metal composite to form a mixture; pulverizing said mixture; and adjusting total solid content in said mixture; characterized in that prior to adjusting the total solid content, subjecting the pulverized mixture to excessive hydroxyl ion and heat above 100° C. to obtain the mixture in a paste form, whereby said step activates and enhances reactivity at ionic and atomic level of the mixture; mixing stabilizer, surfactant and water into said mixture to form said heterogenous composite chemical curative dispersion.

### TECHNICAL FIELD

This invention relates generally to a method of preparing a chemical curative dispersion. More particularly, the present invention relates to a method of preparing a heterogenous composite chemical curative dispersion particularly suitable to make elastomeric articles using dipping, calendaring or spray coating.

### BACKGROUND ART

Elastomeric articles are highly demanded in various industries including the field of chemical, mechanical, electrical, electronics, biological, pharmaceutical, beauty parlours and medical related safety. The use of elastomeric articles including hand gloves, condoms, finger cots, to name a few, which some are critical for cleanliness, protection as well as prevention of injuries or diseases.

The art of making dip-formed elastomeric article involves series of operations. Conceptually the dip-formed elastomeric article is made mainly by a polymer or blend of polymers. The raw polymer used in the making of dip-formed articles are available as polymer in water as emulsion normally called latex. The polymer consists of macro molecules of long array of repetitive monomer blocks suspended in water with suitable surfactants and anions to maintain the emulsion stability. These macro molecular chains are cross linked using ionic and or covalent bonds which in turn results in continuous impervious film. The film strength depends on the crosslinking capacity of the polymer, and number and types of crosslinking agents (molecules). Density of the crosslinking in fact depends on the activeness of the crosslinkers involved in the reaction or the crosslinking process. If the crosslinking agents are not active enough it may not react immediately, some may react upon storage and some may not react until the usage starts, such unreacted crosslinking agents may cause reaction with the article in contact or even with the skin of the wearer in case of article like gloves, condoms and the like. It is therefore a need to ensure a complete reaction of the crosslinking process.

The latex emulsion consists of high molecular polymer particle, which vary with the base polymer and the suspension system. These polymer particles, as a group of multiple molecules, are dispersed in water with suitable surfactants and stabilizers in an anionic state. The ionic curatives mostly available as insoluble polyvalent metallic oxide form to disperse in water, similarly the covalent curatives mostly insoluble sulphur or sulphur donors are also dispersed in water. Conventionally, such dispersions are maintained in the pH range of 8.0 to 10.0, or 9.0 to 11.0. This range is selected to avoid pH shock while adding into the raw latex, for instance the pH of raw nitrile latex will be around pH 8.5. The amount of hydroxide added in the form of potassium hydroxide or ammonium hydroxide are of 0.2-0.6% to the total solution or to the total solids for making the dispersion anionically compatible with the latex that is already available in anionic emulsion form.

There have been several compositions and methods proposed to improve the emulsion composition for making the elastomeric articles, some of these examples are discussed in following prior arts:

Patent Application Publication No. US 2017/0218168 A1 relates to elastomeric articles, compositions, and methods for their production, wherein the compositions are suitable for forming articles through dipping process. The articles and compositions involve the use of a solubilised form of a multivalent metal, in a complex ion form which has an overall negative charge, at a pH of at least 9.0. The solubilised form resulting a homogeneous form as aqueous solution. The multivalent metal then forms crosslinks between carboxyl groups of the carboxylated polymer during the crosslinking or curing stage in the manufacture of the article. The aim is to achieve solubilisation of the multivalent metal and maintenance of the multivalent metal in solution without (or without significant) precipitation of insoluble forms of the multivalent metal during the time of adding the crosslinking agent to the suspension of synthetic carboxylated polymer in water.

U.S. Pat. No. 8,389,620 B2 discloses a dip-forming latex composition containing crosslinking agent and dip-formed article obtained therefrom. The dip-forming composition comprises a carboxyl group-containing diene-based rubber latex, and an internal organometallic crosslinking agent containing one or more metal atom which is bonded to one or two carboxylate group of a carboxylic acid and two or more hydroxyl groups which are bonded to the metal atom, wherein the metal atom is aluminum or titanium. The crosslinking agent capable of replacing zinc oxide, sulfur and a sulfur-containing vulcanizer to improve physical properties of the dip-formed article.

In addition, WO2014034889A1 discloses a glove having improved chemical resistance while maintaining flexibility by being composed of a predetermined combination of elastomers, and a composition for producing the glove. Carboxylated acrylonitrile butadiene elastomer of said invention comprising to 40% by weight acrylonitrile residues and 3 to 8% unsaturated carboxylic acid residues by weight of the elastomer, and neutralization titration of the elastomer combustion product. It is a carboxylated acrylonitrile butadiene elastomer in which the content of elemental sulfur detected by the method is 1% by weight or less of the weight of the elastomer and the Mooney viscosity (ML₍₁₊₄₎ (100° C.)) is 100 to 220.

Accordingly, there still remains a need in the art to optimize physical properties of the elastomeric articles including strength and elongation. Moreover, there is also a need to provide a preparation method of an elastomeric composite with high activeness for the reaction in the process of film formation whilst reducing use of chemicals that creates environmental pollution.

### SUMMARY OF THE INVENTION

The following presents a simplified summary of the invention in order to provide a basic understanding of some aspects of the invention. This summary is not an extensive overview of the invention. Its sole purpose is to present some concepts of the invention in a simplified form as a prelude to the more detailed description that is presented later.

It is an objective of the present invention to provide a method of preparing a heterogeneous composite chemical curative dispersion for making elastomeric article.

It is also an objective of the present invention to provide a preparation of an elastomeric composite with high activeness for the reaction in the process of film formation by supporting chemicals and heat energy.

It is yet another objective of the present invention to provide a method of modifying reactivity of curatives to reduce the consumption of such curatives and yet achieve the targeted properties.

It is a further objective of the present invention to provide a method of reducing particle sizes to increase surface area in the same time enhancing reactivity at ionic and atomic level of curatives with excessive addition of alkaline chemicals and heat supply.

It is also an objective of the present invention to provide an elastomeric composite at a heterogenous state of curative mix comprising multiple phases of solid, solutes in aqueous media with suitable surfactants, stabilizers and thickeners.

Accordingly, these objectives may be achieved by following the teachings of the present invention. The present invention relates to a method of preparing a heterogeneous composite chemical curative dispersion for elastomeric article, the method comprising the steps of: preparing a metal composite; adding alkaline solution in said metal composite to form a mixture; pulverizing said mixture; and adjusting total solid content in said mixture; characterized in that prior to adjusting the total solid content, subjecting the pulverized mixture to excessive hydroxyl ion and heat above 100° C. to obtain the mixture in a paste form, whereby said step activates and enhances reactivity at ionic and atomic level of the mixture; mixing stabilizer, surfactant and water into said mixture to form said heterogenous composite chemical curative dispersion.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

So that the manner in which the above recited features of the present invention can be understood in detail, a more particular description of the invention, briefly summarized above, may have been referred by embodiments, some of which are illustrated in the appended drawings. It is to be noted, however, that the appended drawing illustrates only typical embodiments of this invention and are therefore not to be considered limiting of its scope, for the invention may admit to other equally effective embodiments.

These and other features, benefits, and advantages of the present invention will become apparent by reference to the following text figure, with like reference numbers referring to like structures across the views, wherein:

FIG. 1 is a flowchart illustrating a method of preparing a heterogeneous composite chemical curative dispersion for making elastomeric articles according to an embodiment of the present invention;

FIG. 2 is a flowchart illustrating a repetition step of pulverizing the mixture if the mixture does not form in a paste form after adding excessive hydroxyl ion and heating;

FIG. 3 is a flowchart illustrating a first embodiment of the present invention for preparing a heterogeneous composite chemical curative dispersion using a metal composite comprising a polyvalent metal in the form of oxides or hydroxides; and

FIG. 4 is a flowchart illustrating a second embodiment of the present invention for preparing a heterogeneous composite chemical curative dispersion using a metal composite comprising a polyvalent metal salt.

### DETAILED DESCRIPTION OF THE INVENTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting but merely as a basis for claims. It should be understood that the drawings and detailed description thereto are not intended to limit the invention to the particular form disclosed, but on the contrary, the invention is to cover all modifications, equivalents and alternatives falling within the scope of the present invention as defined by the appended claims. As used throughout this application, the word “may” is used in a permissive sense (i.e., meaning having the potential to), rather than the mandatory sense (i.e., meaning must). Similarly, the words “include,” “including,” and “includes” mean including, but not limited to. Further, the words “a” or “an” mean “at least one” and the word “plurality” means one or more, unless otherwise mentioned. Where the abbreviations or technical terms are used, these indicate the commonly accepted meanings as known in the technical field.

The present invention is described hereinafter by various embodiments with reference to the accompanying drawing, wherein reference numerals used in the accompanying drawing correspond to the like elements throughout the description. This invention may, however, be embodied in many different forms and should not be construed as limited to the embodiment set forth herein. Rather, the embodiment is provided so that this disclosure will be thorough and complete and will fully convey the scope of the invention to those skilled in the art. In the following detailed description, numeric values and ranges are provided for various aspects of the implementations described. These values and ranges are to be treated as examples only, and are not intended to limit the scope of the claims. In addition, a number of materials are identified as suitable for various facets of the implementations. These materials are to be treated as exemplary, and are not intended to limit the scope of the invention.

The present invention relates to a method (100) of preparing a heterogeneous composite chemical curative dispersion for making elastomeric articles particularly dip-formed elastomeric articles. Said method modify reactivity of the curatives in such a way to reduce consumption of such curatives and achieve the desired physical properties of the elastomeric articles. The curatives of the present invention are applicable to anionic polymeric dispersion which are intended to make elastomeric articles using dipping, calendaring or spray coating.

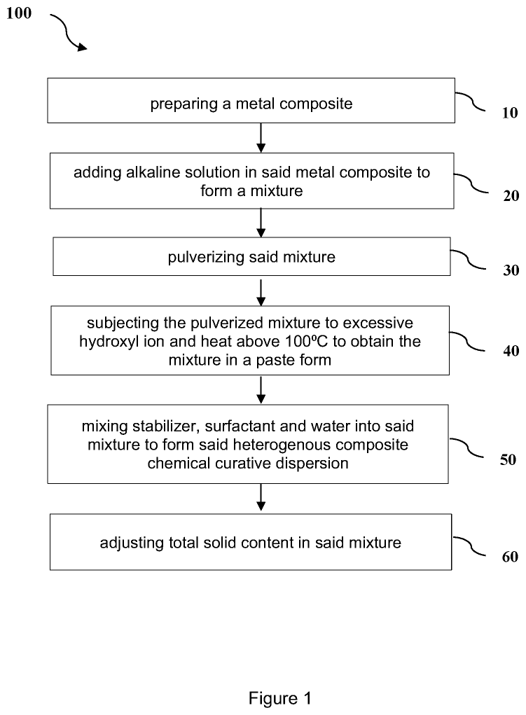

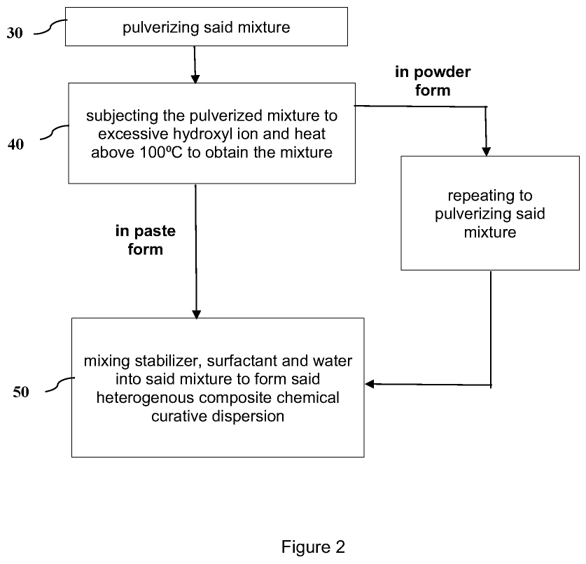

Referring to the drawings as shown in FIGS. 1 to 4, the invention will now be described in more detail.

Referring now to FIG. 1, the method (100) of preparing a heterogeneous composite chemical curative dispersion comprising the steps of: preparing a metal composite (10); adding alkaline solution in said metal composite to form a mixture (20); pulverizing said mixture (30); and adjusting total solid content in said mixture (60); characterized in that prior to adjusting the total solid content, subjecting the pulverized mixture to excessive hydroxyl ion and heat above 100° C. to obtain the mixture in a paste form (40), whereby said step activates and enhances reactivity at ionic and atomic level of the mixture; mixing stabilizer, surfactant and water into said mixture to form said heterogenous composite chemical curative dispersion (50).

In accordance with an embodiment of the present invention, said pulverizing step is repeated if the mixture obtained after subjecting to excessive hydroxyl ion and heat is in powder form. Lower particle sizes in turn will increase the surface area for better reaction and reduces amount of curatives used in the method. Moreover, it also offers easy dispersibility and less settling characteristics which then achieve better and uniform film property. The extent of heating with respect to the temperature and duration varies with respect to the targeted or designed end product characteristics, i.e. elastomeric articles to be obtained using said heterogeneous composite chemical curative dispersion. If the mixture forms powder form resulted from the total dried up, the mixture is pulverized for fine quality product.

In accordance with an embodiment of the present invention, said mixture is pulverized with an average particle size of diameter less than 5 microns for at least 95% of the total number of particles. In a more preferred embodiment, the remaining 5% of the total number of particles is pulverized with an average particle size of diameter less than 15 microns.

In accordance with an embodiment of the present invention, the metal composite comprising a monovalent metal selected from alkali metal comprising lithium, sodium or potassium.

In accordance with another embodiment of the present invention, the metal composite comprising a polyvalent metal selected from alkaline earth metal, transition metal or post transition metal including magnesium, iron, copper, zinc or aluminium. More preferably, the metal composite comprising a polyvalent metal in the form of oxides or hydroxides.

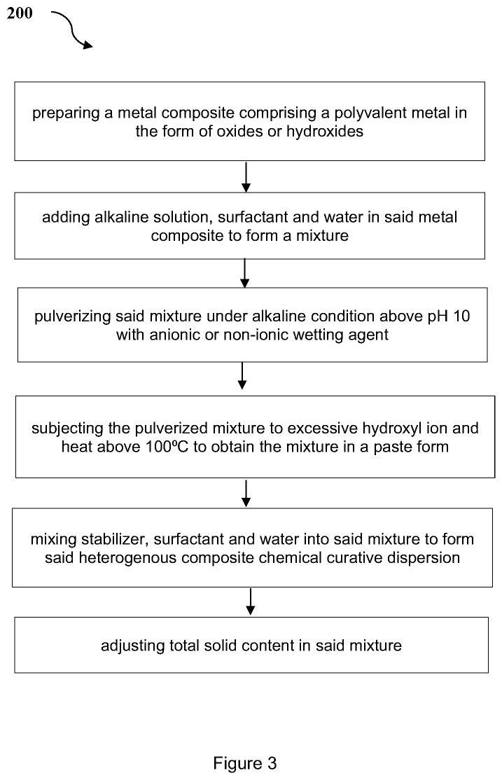

FIG. 3 illustrates a first embodiment of the present invention for preparing a heterogeneous composite chemical curative dispersion using a metal composite comprising a polyvalent metal in the form of oxides or hydroxides. Accordingly, the method (200) comprising the steps of: preparing a metal composite comprising a polyvalent metal in the form of oxides or hydroxides; adding alkaline solution, surfactant and water in said metal composite to form a mixture; pulverizing said mixture under alkaline condition above pH 10 with anionic or non-ionic wetting agent; subjecting the pulverized mixture to excessive hydroxyl ion and heat above 100° C. to obtain the mixture in a paste form; mixing stabilizer, surfactant and water into said mixture to form said heterogenous composite chemical curative dispersion; and adjusting total solid content in said mixture.

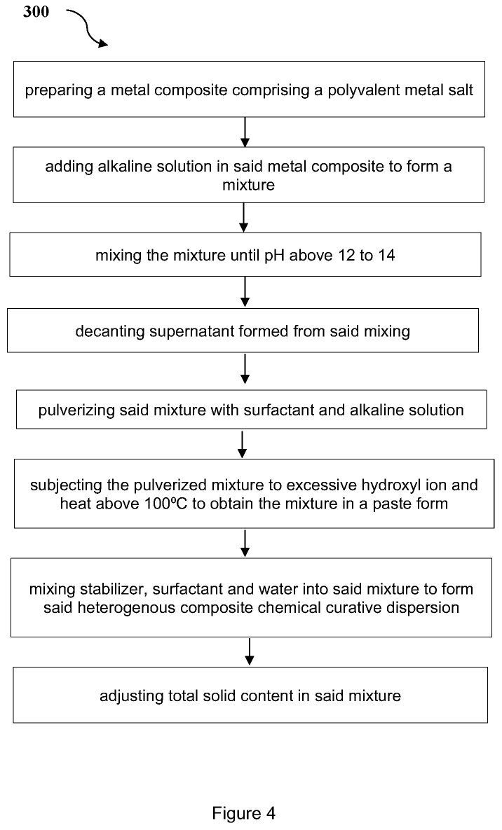

FIG. 4 illustrates a second embodiment of the present invention for preparing a heterogeneous composite chemical curative dispersion using a metal composite comprising a polyvalent metal salt. Accordingly, the method (300) comprising the steps of: preparing a metal composite comprising a polyvalent metal salt; adding alkaline solution in said metal composite to form a mixture; mixing the mixture until pH above 12 to 14; decanting supernatant formed from said mixing; pulverizing said mixture with surfactant and alkaline solution; subjecting the pulverized mixture to excessive hydroxyl ion and heat above 100° C. to obtain the mixture in a paste form; mixing stabilizer, surfactant and water into said mixture to form said heterogenous composite chemical curative dispersion; and adjusting total solid content in said mixture.

The polyvalent metal salt is selected from transition or post transition metal group which is capable of forming crosslink with the curing mechanism of the elastomeric polymer.

In accordance with another embodiment of the present invention, the stabilizer, surfactant and water are mixed with addition of sulphur, sulphur donor or a combination thereof into said mixture. The sulphur or sulphur donor can be in soluble or insoluble form. More preferably, the sulphur or sulphur donor is added when the synthetic copolymer contains diene monomers as part of the total monomer set for making the end product.

In accordance with another embodiment of the present invention, the heterogenous composite chemical curative dispersion comprising 5% to 40% by weight of hydroxides of the alkaline solution.

In accordance with another embodiment of the present invention, the heterogenous composite chemical curative dispersion comprising 25% to 250% by weight of hydroxides of the alkaline solution with respect to the metal composite.

In accordance with another embodiment of the present invention, the heterogenous composite chemical curative dispersion comprising 25% to 400% by weight of hydroxides of the alkaline solution with respect to the metal composite in the form of oxides.

The surfactant used in the present invention is selected from anionic group, non-ionic group or a combination thereof. The stabilizer could be selected from polysaccharides, a reaction product of polysaccharides, salt of alkali metal such as soda ash, salt of gluconic acids such as sodium gluconate, functional cellulose or the like which supports the existence of hydroxyl ions in the solution. The pH may be adjusted by using potassium hydroxide or ammonia.

The activation of the present invention is caused by the excessive hydroxyl ions supplied by the alkaline chemicals and the external heat supplied during the process. It is known to a person skilled in the art that in a chemical reaction, reactants that are not used up when the reaction is finished are call excess reagents. In the present invention, hydroxyl ions are excessive, meaning the amount of hydroxyl ions added are more than enough to complete the reaction. Under heat and excessive supply of hydroxyl ions and in the presence of water, the polyvalent metal ions or polyvalent metal in the form of oxides or hydroxides are enriched with alkaline solution which facilitate the forming of ionic bonds with the acid radicals present in the form of carboxylic acid (—COOH) monomer part along with the rest of the monomers that could be butadiene, acrylo-nitrile, styrene, polychloroprene, vinyl or others capable of forming elastomeric chains with higher freedom of movement between the molecular array.

All the polyvalent metal hydroxides are sparingly soluble or practically insoluble in water. When the polyvalent metal hydroxides are pulverized and heated up with high alkaline condition, the reactivity is enhanced to get better film forming characteristics at less dosage by reacting especially with the carboxylic terminal in the main polymeric chain of single copolymer or when carboxylic acid terminal is presence in the blend of multiple polymers.

Hereinafter, examples of the present invention will be provided for more detailed explanation. It will be understood that the examples described below are not intended to limit the scope of the present invention.

### Examples

The representative chemicals including polyvalent metal oxide, metal hydroxide and metal salt, various alkali including metal hydroxide and ammonium hydroxide were selected to perform a comparative study. The compatible hydroxide stabilizer and surfactant were selected accordingly. The surfactant selected were anionic type or nonionic type to be compatible with the anionic polymeric emulsion.

Table 1 shows a list of curatives set with different formulations which were attempted to explore the various combinations of polyvalent metal oxide, hydroxide and salt with various alkali metal hydroxide and ammonium hydroxide. Numerous combinations were tried to cover the concept of the present invention.

TABLE 1
List of curatives sets

| Sl. | | | No. of |
|---|---|---|---|
| No. | Description | Reference | sets |
| 1 | ZnO/Al₂O₃/NaOH/KOH | SLC 1-6; 10-13; 30 | 11 |
| 2 | ZnO/NaOH/KOH | SLC 7, 8; SLCA 8 | 3 |
| 3 | ZnSO₄/NaOH/KOH | SLC 9, 28 | 2 |
| 4 | MgO/Al₂O₃/NaOH | SLC 14, 29 | 2 |
| 5 | CuSO₄/Al₂O₃/NaOH | SLC 15 | 1 |
| 6 | PFS/Al₂O₃/NaOH | SLC 16 | 1 |
| 7 | PFS/CuSO₄/MgO/Al₂O₃/NaOH | SLC 17 | 1 |
| 8 | Al₂(SO₄)₃/NaOH | SLC 18 | 1 |
| 9 | ZnSO₄/Al₂(SO₄)₃/NaOH | SLC 19 | 1 |
| 10 | ZnO/NH₄OH | SLC 20 | 1 |
| 11 | ZnO/Al₂O₃/NaOH/NH₄OH | SLC 21, 22 | 2 |
| 12 | Zn(OH)₂/NaOH | SLC 23 | 1 |
| 13 | MgO/Zn(OH)₂/Al₂O₃ | SLC 24, 26, 27, 32, 33 | 5 |
| 14 | Zn(OH)₂/Al₂O₃/NaOH/NH₄OH | SLC 25 | 1 |
| 15 | Al₂O₃/NaOH/KOH | SLC 31 | 1 |
| 16 | ZnO (Regular composite with | SLC 34 | 1 |
| | normal alkaline) | | |
| 17 | Al₂O₃/KOH | SLC 35 | 1 |
| 18 | Al₂O₃/KOH/ZnO | SLC 36 | 1 |
| 19 | Al₂O₃/KOH/NaOH/ZnO | SLC 37 | 1 |

Abbreviation: SLC stands for Superior Latex Composite

Based on the above combination of curative materials as set forth in Table 1, eighty-eight (88) individual experiments were carried out as appended in Table 3. This comprised two (2) experiments from conventional composite material with regular pH level and SLC 34 in conventional method at nominal pH. The rest were prepared according to the present method. The following examples are given to describe the invention in detail with reference to non-limiting embodiments.

TABLE 2
List of different formulations with different set of curatives

| | SLC1 | SLC2 | SLC3 | SLC4 | SLC5 | SLC6 | SLC7 | SLC8 | SLCA8 |
|---|---|---|---|---|---|---|---|---|---|
| Al₂O₃ | 12.4 | 6.2 | 6.2 | 9.3 | 9.3 | 9.3 | 0.0 | 0.0 | |
| NaOH | 9.8 | 4.9 | 4.9 | 7.3 | 7.3 | 7.3 | 0.0 | 0.0 | |
| ZnO | 2.25 | 5.25 | 20 | 15 | 15 | 15 | 22 | 22 | 19 |
| NaOH | 2.25 | 5.25 | 20 | 15 | 15 | 0 | 4 | 5 | 24 |
| KOH | | | 0 | 0 | 0 | 15 | 15 | 10 | |
| TEA | 2 | 1 | 2 | 2 | 2 | 2 | 0 | | |
| Na₂CO₃ | 4 | 2 | 2 | 5 | 5 | 5 | 10 | 14 | |
| Sodium Gluconate | 4 | 2 | 4 | 5 | 5 | 5 | 3 | 3 | 6 |
| Starch | 0.6 | 0.5 | 0.5 | 0.5 | 0.5 | 0.7 | 0 | 0 | |
| Maltodextrin | | | | | 0.5 | 0 | 1 | 1 | |
| Sugar | | | 2.5 | 3 | 3 | 34.65 | 3 | 3 | 3 |
| SLES | | | 2 | 3 | 3 | 3 | 3 | 3 | 3 |
| Water | 62.7 | 72.9 | 35.9 | 34.85 | 34.35 | 34.65 | 39 | 39 | 45 |
| | 100 | 100 | 100 | 100 | 100 | 100 | 100 | 100 | 100 |

| | SLC9 | SLC10 | SLC11 | SLC12 | SLC13 | SLC14 | SLC15 | SLC16 | SLC17 |
|---|---|---|---|---|---|---|---|---|---|
| PFS | | | | | | | | 7.5 | 2.5 |
| CuSO₄ | | | | | | | 20 | 0 | 6.7 |
| MgO | | | | | | 5 | | 0 | 1.7 |
| ZnSO₄ | 22 | | | | | | | | |
| Al₂O₃ | 0.0 | 9.3 | 9.3 | 4.7 | 4.7 | 9.3 | 6.2 | 6.2 | 7.3 |
| NaOH | 0.0 | 7.3 | 7.3 | 3.7 | 3.7 | 7.3 | 4.9 | 4.9 | 5.7 |
| ZnO | 0 | 15 | 15 | 18.5 | 18.5 | 0 | 0 | 0 | 0.0 |
| NaOH | 16 | | 7.5 | 2 | 2.5 | 15 | 15 | 15 | 15.0 |
| KOH | 5 | 15 | 7.5 | 15 | 12.5 | 0 | 0 | 0 | |
| TEA | | 2 | 2 | 1 | 1 | 2 | 2 | 2 | 2.0 |
| Na₂CO₃ | | 5 | 5 | 7.5 | 9.5 | 3 | 3 | 3 | 3.0 |
| Sodium Gluconate | 3 | 5 | 5 | 4 | 4 | 3 | 3 | 3 | 3.0 |
| Starch | 0 | 1 | 0.6 | 0.35 | 0.35 | 0.5 | 0.5 | 0.5 | 0.5 |
| Maltodextrin | 1 | 0.5 | 0.25 | 0.5 | 0.5 | 1 | 0.5 | 0.5 | 0.7 |
| Sugar | 3 | 3 | 3 | 3 | 3 | 3 | 3 | 3 | 3.0 |
| SLES | 3 | 3 | 3 | 3 | 3 | 0 | | | |
| Water | 47 | 33.85 | 34.5 | 36.83 | 36.83 | 50.85 | 41.9 | 54.4 | 49.05 |
| | 100 | 100 | 100 | 100.0 | 100 | 100 | 100 | 100 | 100 |

| | SLC18 | SLC19 | SLC20 | SLC21 | SLC22 | SLC23 | SLC24 | SLC25 | SLC26 |
|---|---|---|---|---|---|---|---|---|---|
| MgO | | | | | | | 2.5 | | 1.42 |
| ZnSO₄ | | 11 | | | | | 0 | | |
| Zn(OH)₂ | | 0 | | | | 25 | 12.5 | 25 | 15 |
| Al₂(SO₄)₃ | 20 | 10 | | | | | 0 | | |
| Al₂O₃ | 0.0 | 0.0 | 0.0 | 4.7 | 17.7 | 0.0 | 4.7 | 6.2 | 6.2 |
| NaOH | 0.0 | 0.0 | 0.0 | 3.7 | 13.9 | 0.0 | 3.7 | 4.9 | 4.9 |
| ZnO | 0 | 0 | 20 | 17.5 | 14.25 | 0 | 0 | 0 | 0 |
| NaOH | 20 | 18 | | 0 | | 25 | 20 | 10 | 5 |
| KOH | | 2.5 | | 7.5 | | | 0 | | 15 |
| Am-25% | | 0 | 40 | 20 | 28.5 | | 0 | 25 | |
| TEA | 2 | 1 | 2 | 2 | 1.4 | 2 | 2 | 2 | 2 |
| Na₂CO₃ | 0 | 0 | 0 | 2.5 | | 0 | 1.5 | | |
| Sodium Gluconate | 3 | 3 | 3 | 4 | 2 | 3 | 3 | 3 | 3 |
| Starch | 1 | 0.5 | 1 | 0.85 | 0.7 | 0.6 | 0.55 | 0.5 | 0.5 |
| Maltodextrin | 1 | 1 | 0.5 | 0.25 | 0.4 | 0.5 | 0.75 | 0.5 | 0.5 |
| Sugar | 3 | 3 | 3 | 3 | 2 | 3 | 3 | 3 | 3 |
| SLES | | 1.5 | | 1.5 | | | 0 | | |
| Water | 50 | 48.5 | 30.5 | 32.575 | 19.115 | 40.9 | 45.875 | 19.9 | 43.48 |
| | 100 | 100 | 100 | 100 | 100 | 100 | 100 | 100 | 100 |

| | SLC27 | SLC28 | SLC29 | SLC30 | SLC31 | SLC32 | SLC33 | SLC34 | SLC35 | SLC36 | SLC37 |
|---|---|---|---|---|---|---|---|---|---|---|---|
| MgO | 0.71 | | 4 | | | 3.33 | 1.67 | | | | |
| ZnSO₄ | 0 | 17.0 | | | | | 0 | | | | |
| Zn(OH)₂ | 20 | | | | | 5 | 2.5 | | | | |
| Al₂O₃ | | | | | | | | | 15.6 | 7.8 | 7.8 |
| KOH | | | | | | | | | 17.13 | 8.565 | 8.565 |
| Al₂O₃ | 6.2 | 0.0 | 7.5 | 6.2 | 12.4 | 9.3 | 10.9 | 0.0 | 0.0 | 0.0 | 4.7 |
| NaOH | 4.9 | 0.0 | 5.9 | 4.9 | 9.8 | 7.3 | 8.5 | 0.0 | 0.0 | 0.0 | 3.7 |
| ZnO | 0 | 0.0 | 0 | 10 | 0 | 0 | 0 | 50 | 0 | 16.65 | 7.5 |
| NaOH | 7.5 | 12.5 | 12 | 15 | | 10 | 5 | | | 0 | 0 |
| KOH | 7.5 | 4.0 | 0 | | 15 | | 7.5 | | 10 | 21.7 | 12.5 |
| Am-25% | 12.5 | 0.0 | 0 | | | | 0 | | | 0 | 0 |
| TEA | 2 | 0.0 | 2 | 2 | 2 | 2 | 2 | | 2 | 1 | 2 |
| Na₂CO₃ | | 0.0 | 2.5 | 0 | | | 0 | | | 0 | 2.5 |
| Sodium Gluconate | 3 | 2.3 | 2.5 | 3 | 3 | 3 | 3 | | 3 | 1.5 | 4 |
| Starch | 0.5 | 0.0 | 0.4 | 0.5 | 0.5 | 0.5 | 0.5 | | 0.8 | 0.4 | 0.9 |
| Maltodextrin | 0.5 | 0.8 | 0.8 | 0.5 | 0.5 | 0.5 | 0.5 | | 1 | 0.5 | 0.75 |
| Sugar | 3 | 2.3 | 2.5 | 2 | 3 | 3 | 3 | | 3 | 1.5 | 3 |
| SLES | | 3.0 | 0 | 3 | 3 | 3 | 3 | | 2 | 1 | 1.5 |
| Sulphur | | 2.8 | 2.65 | 2.5 | 5 | 5 | 5 | | | 0 | 0 |
| ZDBC | | 2.8 | 2.65 | 2.5 | 2.5 | 2.5 | 2.5 | | | 0 | 0 |
| Water | 31.69 | 52.6 | 54.68 | 47.9 | 43.3 | 45.52 | 44.405 | 50 | 45.47 | 39.385 | 40.66 |
| | 100 | 100 | 100 | 100 | 100 | 100 | 100 | 100 | 100 | 100 | 100 |

Nomenclature:
TEA—Triethanolamine
SLES—Sodium Lauryl Ether Sulphate
Am-25%—Ammonium Hydroxide 25% strength
ZDBC—Zinc Dibutyl Dithio Carbomate

### Method of Evaluation

### Dilution of Composite

The formulated composites in Table 1 were evaluated by using the composite as crosslinking agent in the latex formulations as per the conventional techniques of compounding that is known to a person skilled in the art. Due to the high pH of the composite, the composite was prepared before addition to the latex emulsion especially for carboxylated nitrile butadiene rubber or similar crboxylated synthetic rubber or to the blend where the carboxylated rubber form a part of the blend. The required quantity of composite was mixed and transferred to a non-corrosive vessel before use. Then, equal amount of water was added and mixed uniformly. Next, three times of water quantity and six times of water quantity to that of original composite quantity were added subsequently after each was mixed uniformly. Alkaline water was added instead of soft or deionized water to avoid any pH shock which may result precipitation or soft gel like separation. The adding was performed slowly to attain better uniformity.

### Compounding Using Composite

The commercial carboxylated latex of acrylo-nitrile butadiene at 45% concentration was used in this study. The latex emulsion was diluted to about 30% of total solid content (TSC) level using alkaline water to obtain a final pH of diluted latex around 10. Anionic surfactant such as sodium dodecyl benzene sulphonate or equivalent could be used in the dilution process to avoid coagulation or formation of micro lump particles.

The diluted composite was added slowly to the pre-diluted latex under constant stirring. Creation of bubbles or vortex formation should be avoided. The stirring rate was between 60-100 rpm, depending on the size of the stirrer and tank. The entire addition time was performed for 1-45 minutes depending on the batch size and the amount of composite used. The recommended addition level of the composite could be 0.25-1.0 phr (parts per hundred parts of rubber) on dry basis depending on the conventional calculation to 100 parts of rubber.

Other additives specific to the end product characteristic was added, including organic or inorganic filler, biodegradation additives, colorants, wax, electrostatic dissipative additive, components for detection purposes through scanning, antimicrobial additives, scents or flavours and other special additives if any.

Once all the additives were added, the compound was left for maturation under constant stirring for about 8-36 hours depending on the process conditions warranted.

The general level of TSC for composite is 50%. The amount shown in all the experiments correspond to the wet basis considering 50% was the actual TSC of composite. For example, 2 phr of composite phr means 1 phr of dry composite solids, in some cases the actual curative percentage will be much less to the overall weight of the composite. All other additives and latex are calculated on dry basis for example latex 100 phr means dry rubber component is 100 parts whereas the equivalent wet at 45% concentration will be 222 parts including water. Since the composite phr alone in wet basis the SLC 34 which is conventional dispersion of ZnO is also calculated in wet basis.

The performance was evaluated by checking the physical property of the film. The physical property evaluation comprised of the tensile strength, modulus, elongation and force at break. The film formed varied from 0.04 to 0.06 at the testing point. The physical property test was done as per regular test method recommended by international standard for elastomeric articles.

A small lab batch compound was made using the latex containing carboxylic acid monomer, nitrile monomer and butadiene monomer, in this case carboxylated acrylonitrile butadiene rubber (NBR) latex was selected. The film was formed over ceramic mould. The film formation was enabled by deposition on the divalent salt coating which contains cationic material to enable easy deposition of rubber molecules which were in anionic state. In this case the salt selected was calcium nitrate.

The mould was cleaned to ensure no dirt or oil traces present on the mould which may affect the uniform film formation. The cleaned mould then dried and dipped in the coagulant bath containing calcium nitrate and surfactant/wetting agent in water media. The coagulant coated mould was dried up, to remove excess water and dipped in to the formulated (using novel composite) latex emulsion. The deposited film was then leached in water, then dried and heated up approximately 120° C. or 135° C. for about 20 or 30 mts for a film thickness of about 2-4 mil. The cured material was again leached and coated and dried.

### Experiment Plan

Three types of carboxylated nitrile butadiene rubber (NBR) consist of different strength were used, which includes NBR latex Type 1 with medium strength, Type 2 with high tensile strength and Type 3 with low medium strength.

TABLE 3
Eighty-eight experiment sets with different formulations

| Experiment no. | 1 | 2 | 3 | 4 | 5 | 6 | 7 | 8 | 9 | 10 |
|---|---|---|---|---|---|---|---|---|---|---|
| NBR Latex Type 1 | 100 | 100 | 100 | 100 | 100 | 100 | 100 | 20 | 100 | 100 |
| NBR Latex Type 2 | 0 | 0 | 0 | 0 | 0 | 0 | 0 | 80 | 0 | 0 |
| Composite Type | SLC1 | SLC1 | SLC2 | SLC1 | SLC2 | SLC2 | SLCA8 | SLCA8 | SLC3 | SLC3 |
| Composite phr | 1.5 | 1.5 | 1 | 1.3 | 1.5 | 1.3 | 1.5 | 1.5 | 1 | 1.5 |
| KOH | 0.8 | 1.5 | 1.5 | 1.5 | 1.5 | 1.5 | 2 | 2 | 2 | 2 |
| Solubilized Sulphur | 0 | 0 | 0 | 0.2 | | 0.2 | | | | |
| TiO₂ | 2 | 2 | 2 | 2 | 2 | 2 | 2 | 2 | 2 | 2 |

| Experiment no. | 11 | 12 | 13 | 14 | 15 | 16 | 17 | 18 | 19 | 20 |
|---|---|---|---|---|---|---|---|---|---|---|
| NBR Latex Type 1 | 100 | 100 | 100 | 100 | 100 | 100 | 100 | 100 | 100 | 100 |
| Composite Type | SLC4 | SLC4 | SLCA8 | SLCA8 | SLCA8 | SLCA8 | SLCA8 | SLCA8 | SLC3 | SLC4 |
| Composite phr | 1 | 1.5 | 1 | 1.5 | 2 | 2 | 2 | 2 | 2 | 2 |
| KOH | 2 | 2 | 2 | 2 | 1 | 2 | 1 | 2 | 1.5 | 1.5 |
| Solubilized Sulphur | | | | | | | 0.3 | 0.15 | | |
| TiO₂ | 2 | 2 | 2 | 2 | 2 | 2 | 2 | 2 | 2 | 2 |

| Experiment no. | 21 | 22 | 23 | 24 | 25 | 26 | 27 | 28 | 29 | 30 |
|---|---|---|---|---|---|---|---|---|---|---|
| NBR Latex Type 1 | 100 | 100 | 100 | 100 | 100 | 100 | 100 | 100 | 100 | 100 |
| Composite Type | SLC3 | SLC4 | SLC5 | SLC5 | SLC6 | SLC6 | SLC6 | SLC6 | SLC7 | SLC7 |
| Composite phr | 2 | 2 | 2 | 1.5 | 2 | 1.5 | 1 | 1.5 | 1 | 1.5 |
| KOH | 1.5 | 1.5 | 1 | 2 | 1.5 | 2 | 1.5 | 2 | 2 | 1.5 |
| Solubilized Sulphur | 0.2 | 0.2 | | | | | | | | |
| BC-50% | 0.4 | 0.4 | | | | | | | | |
| TiO₂ | 2 | 2 | 2 | 2 | 2 | 2 | 2 | 2 | 2 | 2 |

| Experiment no. | 31 | 32 | 33 | 34 | 35 | 36 | 37 | 38 | 39 | 40 |
|---|---|---|---|---|---|---|---|---|---|---|
| NBR Latex Type 1 | 100 | 100 | 100 | 100 | 100 | 100 | 100 | 100 | 100 | 100 |
| Composite Type | SLC8 | SLC8 | SLC9 | SLC9 | SLC11 | SLC11 | SLC12 | SLC12 | SLC13 | SLC13 |
| Composite phr | 1 | 1.5 | 1 | 2 | 1 | 2 | 1 | 2 | 1 | 2 |
| KOH | 1.5 | 1.5 | 1.5 | 1.5 | 1.5 | 1.5 | 1.5 | 1.5 | 1.5 | 1.5 |
| TiO₂ | 2 | 2 | 2 | 2 | 2 | 2 | 2 | 2 | 2 | 2 |

| Experiment no. | 41 | 42 | 43 | 44 | 45 | 46 | 47 | 48 | 49 | 50 |
|---|---|---|---|---|---|---|---|---|---|---|
| NBR Latex Type 1 | 100 | 100 | 100 | 100 | 100 | 100 | 100 | 100 | 100 | 100 |
| Composite Type | SLC10 | SLC10 | SLC14 | SLC14 | SLC15 | SLC15 | SLC16 | SLC16 | SLC17 | SLC17 |
| Composite phr | 1 | 2 | 1 | 2 | 1 | 2 | 1 | 2 | 1 | 2 |
| KOH | 1.5 | 2 | 2 | 2 | 2 | 2 | 2 | 2 | 2 | 2 |
| TiO₂ | 2 | 2 | 2 | 2 | 2 | 2 | 2 | 2 | 2 | 2 |
| Experiment no. | 51 | 52 | 53 | 54 | 55 | 56 | 57 | 58 | 59 | 60 |
| NBR Latex Type 1 | 100 | 100 | 100 | 100 | 100 | 100 | 100 | 100 | 100 | 100 |
| Composite Type | SLC18 | SLC19 | SLC20 | SLC21 | SLC22 | SLC22 | SLC23 | SLC23 | SLC24 | SLC24 |
| Composite phr | 1 | 2 | 2 | 2 | 1 | 2 | 1 | 2 | 1 | 2 |
| KOH | 2 | 2 | 2 | 2 | 2 | 2 | 2 | 2 | 2 | 2 |
| TiO₂ | 2 | 2 | 2 | 2 | 2 | 2 | 2 | 2 | 2 | 2 |
| Experiment no. | 61 | 62 | 63 | 64 | 65 | 66 | 67 | 68 | 69 | 70 |
| NBR Latex Type 1 | 100 | 100 | 100 | 100 | 100 | 100 | 100 | 100 | 100 | 100 |
| Composite Type | SLC25 | SLC25 | SLC26 | SLC26 | SLC27 | SLC27 | SLC28 | SLC29 | SLC30 | SLC30 |
| Composite phr | 1 | 2 | 1 | 2 | 1 | 2 | 2.3 | 2.3 | 1.5 | 3 |
| KOH | 2 | 2 | 2 | 2 | 2 | 2 | 2 | 2 | 2 | 2 |
| TiO₂ | 2 | 2 | 2 | 2 | 2 | 2 | 2 | 2 | 2 | 2 |
| Experiment no. | 71 | 72 | 73 | 74 | 75 | 76 | 77 | 78 | 79 | 80 |
| NBR Latex Type 1 | 100 | 100 | 100 | 100 | 100 | 100 | 100 | 100 | 100 | 100 |
| Composite Type | SLC10 | SLC10 | SLC31 | SLC31 | SLC32 | SLC32 | SLC33 | SLC33 | SLC34 | SLC34 |
| Composite phr | 1.5 | 2 | 1.5 | 2 | 1.5 | 2 | 1.5 | 2 | 1 | 2 |
| KOH | 2 | 2 | 2 | 2 | 2 | 2 | 2 | 2 | 2 | 2 |
| Silica filler | 6 | 12 | 0 | 0 | 0 | 0 | 0 | 0 | 0 | 0 |
| TiO₂ | 2 | 2 | 2 | 2 | 2 | 2 | 2 | 2 | 2 | 2 |

| Experiment no. | 81 | 82 | 83 | 84 | 85 | 86 | 87 | 88 |
|---|---|---|---|---|---|---|---|---|
| NBR Latex Type 1 | 0 | 0 | 100 | 100 | 100 | 100 | 100 | 100 |
| NBR Latex Type 3 | 100 | 100 | 0 | 0 | 0 | 0 | 0 | 0 |
| Composite Type | SLC34 | SLC10 | SLC35 | SLC35 | SLC36 | SLC36 | SLC37 | SLC37 |
| Composite phr | 2 | 2 | 1 | 2 | 1 | 2 | 1 | 2 |
| KOH | 2 | 2 | 2 | 2 | 2 | 2 | 2 | 2 |
| Sulphur-50% | 2 | 2 | | | | | | |
| ZDBC-50% | 2 | 2 | | | | | | |
| TiO₂ | 2 | 2 | 2 | 2 | 2 | 2 | 2 | 2 |

### Experiment 1

SLC1 was prepared according to first embodiment as per FIG. 3. ZnO and Al₂O₃ were prepared separately and mixed to form SLC1, however it is possible to mix both oxides initially and process as per flow in FIG. 3. The reason for having separate entity is that for varying the ratio between ZnO and Al₂O₃ separate preparation is convenient. In this experiment 1 the composite used is 1.5 phr wet (0.22 phr dry); KOH—0.8. The physical property values are nominal, soft and with high elongation.

### Experiment 2

Experiment 2 was similar to Experiment 1, except the KOH phr, which was 1.5 against 0.8. In both the experiments, the amount of polyvalent metal oxide was of dry phr, even at this level the physical properties are good. Compared to experiment 1 the physical properties of experiment 2 was better due to the higher level of KOH.

### Experiment 3

In this experiment 3, SLC2 composite was used, even less phr (1.0) and the overall metal oxide was 0.115 phr, the physical properties were almost equal to experiment 1, this could be due to higher KOH phr and the different combination of polyvalent metal oxide.

### Experiment 4

Experiment 4 had similarity to experiment 2, with minor reduction in composite phr 1.3 wet (0.19 phr dry) and solubilized sulphur was the extra addition. The physical properties of experiment 2 was better than that of experiment 4. The presence of solubilized sulphur did not give any boost in the physical property. However, the elongation after aging had increased that could be the effect of covalent bond rendered by sulphur.

### Experiment 5

Experiment 5 had similarity to experiment 3, except higher composite phr of 1.5 (0.17 phr of overall multivalent metal oxide). This high phr was reflected in higher values of physical property.

### Experiment 6

Experiment 6 had similarity to experiment 5 with minor reduction in composite phr 1.3 wet (0.15 phr dry) and introduction of solubilized sulphur. There was a considerable reduction in physical properties in experiment 6. With SLC2 the introduction of solubilized sulphur did not have any boost in the properties, at least with SLC1 there was increased in elongation in after aging condition.

### Experiment 7

In this experiment SLCA8 only single type of poly valent metal oxide was used (ZnO), the total actual phr of poly valent metal oxide was 0.285 phr (wet basis 1.5 phr). To the tune of curative the physical property results were good, which was attributed to activation process.

### Experiment 8

Experiment 8 was similar to experiment 7 with the change in the raw NBR latex source. In this experiment two types of latex were used; the results were much better and the tensile reached up to 32 MPa for the same cure set. This could be due to the high strength latex. Composite phr of 1.5 wet (0.29 phr dry) was used.

### Experiment 9

In this experiment 9, SLC3 cure set was used at the tune of 1 phr wet (0.26 phr dry), The physical properties results were nominal, but the film was soft and more flexible.

### Experiment 10

This experiment 10 was similar to experiment 9 with higher curative of 1.5 phr wet (0.39 phr dry), obviously the film strength was higher compared to the experiment 9.

### Experiment 11

In this experiment 11, cure set SLC4 was used at the tune of 1 phr wet (0.24 phr dry). The physical properties were good even with less curative.

### Experiment 12

Experiment 12 was similar to experiment 11 but the curative used was higher 1.5 phr wet (0.36 phr dry). The physical properties were less than that of experiment 11 at the unaged condition. However, in the aged condition it was higher in experiment 12 and as well modulus at M500 was consistently higher than in both unaged and aged conditions. The force at break (FAB) of experiment 12, was high in both unaged and aged conditions.

### Experiment 13

Experiment 13 was similar to experiment 7 using SLCA8 but at lower curative of 1 phr wet (0.19 phr dry) and obviously the tensile values were lower but the glove was soft and more flexible.

### Experiment 14

Experiment 14 used SLCA8 and exactly similar to experiment 7. The reason was to repeat the test in another occasion and different day. The unaged tensile was exactly same in both the cases of experiment 7 and 14. In other readings have some variation however they were comparable. Composite phr of 1.5 wet (0.29 phr dry) was used.

### Experiment 15

The experiments 13 to 18 used SLCA8 with changes in curative level and KOH in the compound. From 13 to 15 the curative phr (wet) was increased in steps of 0.5 from 1, 1.5 and 2. In this experiment 15, the KOH was reduced to 1 phr. Even though the curative was 2 phr, the physical properties were low compared to the 13 & 14 where the curative was less. This is attributed to the low KOH in the compound. This implies the activation of poly valent metal ions are deactivated if the conducive condition is not available in the final compound. However, after aging the result was in accordance with high cure content. Composite phr of 2 wet (0.38 phr dry) was used.

### Experiment 16

Experiment 16 was similar to experiment 15 except the phr level of KOH. In this case of experiment 16, the KOH phr level was raised to 2. This resulted in very good improvement of physical properties. The raise was substantial implying the activation level of polyvalent metal ions were not disturbed much under the high alkaline condition of the compound. Having said that, the high alkaline condition of the compound enables better physical properties. Composite phr of 2 wet (0.38 phr dry) was used.

### Experiment 17

Experiment 17 similar to experiment 15 with respect to curative and KOH in compound, however additional covalent curative sulphur was added in experiment 17. Notably the physical property had come down after adding sulphur. Composite phr of 2 wet (0.38 phr dry) was used.

### Experiment 18

Experiment 18 similar to experiment 17 which containing similar cure set but the KOH was high and sulphur was less in experiment 18. Experiment 18 showed good physical properties compared to experiment 17, could be due to higher KOH and less sulphur. Composite phr of 2 wet (0.38 phr dry) was used.

### Experiment 19

Experiment 19 was made with cure set SLC3, it was almost in line with experiment 9 and 10, with higher curative slightly less KOH (1.5 against 2.0). However, the product weight in this experiment was higher by about 30% (2.5 gm to 3.3 gm). Due to high curative and film weight the physical property was good. The after-aging results were very good. Composite phr of 2 wet (0.52 phr dry) was used.

### Experiment 20

Experiment 20 was made with cure set SLC4, it was almost in line with experiment 11 and 12, with higher curative slightly less KOH (1.5 against 2.0). However, the product weight was higher by about 30% (2.5 gm to 3.3 gm). Due to high curative and film weight the physical property was good. The after-aging results were very good. Composite phr of 2 wet (0.49 phr dry) was used.

### Experiment 21

Experiment 21 was similar to experiment 19 using SLC3 cure set, and with an addition of sulphur and accelerator. The physical properties were comparable and the after-aging property was better. Composite phr of 2 wet (0.52 phr dry) was used.

### Experiment 22

Experiment 22 was similar to experiment 20 using SLC 4 cure set, and with an addition of sulphur and accelerator. The physical properties were closer but not better than experiment 20. Composite phr of 2 wet (0.49 phr dry) was used.

### Experiment 23

Experiment 23 used SLC5 cure set. The physical properties were good. Composite phr of 2 wet (0.49 phr dry) was used.

### Experiment 24

Experiment 24 used SLC5 cure set like experiment 23 with reduction in curative (1.5 against 2.0) and increase in KOH. Even though the cure set was less, the physical properties were much better than experiment 23. This could be due to higher KOH in experiment 24. Composite phr of 1.5 wet (0.36 phr dry) was used.

### Experiment 25

Experiment 25 used cure set SLC6, the curative phr was 2 wet (0.48 dry) and KOH in the compound was 1.5. The physical properties were good.

### Experiment 26

Experiment 26 was similar to experiment 25, with interchange in phr values of KOH and curatives. The physical property was higher than experiment 6 product even with low curative phr 1.5 wet (0.36 dry) due to high KOH.

### Experiment 27

In the experiment 27, the curative had been reduced to half of that of experiment 25 keeping other parameters constant. Even with low curative the unaged results were closer but the aged result was low. Composite phr of 1 wet (0.24 phr dry) was used.

### Experiment 28

Experiment 28 was same as experiment 26 however to check the repeatability it was done some other occasion. The variation was substantial, this could be due to inherent variations in the heterogeneous system. However, the results were still good crossing 35 MPa in both unaged and aged. The aged results were better than experiment 27, which has less curative than experiment 28. Composite phr of 1.5 wet (0.36 phr dry) was used.

### Experiment 29

In this experiment 29, cure set of SLC7 was used at low level of 1 phr wet (0.22 phr dry) and high level of KOH—2 phr was used. The physical property results were ok to the normal requirements crossing 25 MPa in both unaged and aged test conditions.

### Experiment 30

Experiment 30 had similarity to experiment 29 using SLC7 cure set. However, in this case the curative was increased by 0.5 phr wet and KOH was reduced by 0.5 phr. It was like a sort of mixed effect balancing between cure set and KOH keeping the total constant. The unaged tensile was almost same, however aged tensile showed some increase compared to low level of cure set, which was observed in earlier cases also. Composite phr of 1.5 wet (0.33 phr dry) was used.

### Experiment 31

Experiment 31 was done with cure set SLC8 with low phr of cure set 1 phr wet (0.22 dry) and KOH level of 1.5 phr. The tensile results were not high just nominal; however, it was soft and with high elongation and the article was comfortable for use. This kind of property is sought for some product application where the comfort of wearing is a key aspect.

### Experiment 32

Experiment 32 had similarity to experiment 31 using SLC8 as cure set, KOH was same for both at the level of 1.5, however the cure was 1.5 phr wet (0.33 dry). Obviously, the strength aspects of experiment 32 was better than experiment 31.

### Experiment 33

Experiment 33 was made by using SLC9 which was peculiar and different than conventional dispersion, SLC9 was made from Zinc Sulphate salt. The amount of cure set was 1 phr wet (0.22 dry) and KOH at 1.5 phr. The strength was low only but the softness was excellent and elongation was high even at the aged condition. The reason was obvious that the Zn content in ZnSO4 was only 40% whereas in the case of ZnO the Zn content was double the amount (80%). However, the ZnSO4 provided a different spectrum of properties for the phr based on weight.

### Experiment 34

Experiment 34 also similar to experiment 33, however, the SLC9 is high at 2 phr wet (0.44 dry). Obviously, the unaged tensile value was high compared to experiment 33, the softness and high elongation was very close to experiment 33.

### Experiment 35

Experiment 35 was made using SLC11 cure set with 1 phr wet (0.24 phr dry), KOH at 1.5 phr. The physical property results were ok, with nominal range and at the same time with less modulus and high elongation.

### Experiment 36

Experiment 36 was similar to experiment 35 with cure set of SLC 11 at higher phr of 2 wet (0.49 phr dry) was used. The KOH level of 1.5 phr was used in both experiment 35 and 36. Since the cure level was high, obviously the physical property was better in experiment 36 resulting in strong film with much higher crosslinking density.

### Experiment 37

Experiment 37 used SLC12 cure set at the tune of 1 phr wet (0.23 phr dry); KOH was at the level of 1.5 phr. The results were very close and almost similar to experiment 35.

### Experiment 38

Experiment 38 was in line with experiment 37 using cure set of SLC12 at higher phr of 2 wet (0.46 phr dry), and KOH of 1.5 phr. As for the physical properties were concerned, there was no appreciable difference in tensile values, the modulus after aging was much higher compared to experiment 37. However, the impact of higher curative level (double) was not felt in the properties.

### Experiment 39

Experiment 39 used cure set of SLC13 at 1 phr wet (0.23 dry phr) at KOH phr of 1.5. The product was soft with low modulus and high elongation and the tensile was nominal.

### Experiment 40

Experiment 40 was in line with experiment 39 using SLC13, with higher phr of 2 wet (0.46 dry); KOH at 1.5 phr. The physical properties obtained were at the higher side, resulting in strong film. The unaged tensile was about 50% higher than that of experiment 39.

### Experiment 41

Experiment 41 used SLC10 cure set at the tune of 1 phr wet (0.24 phr dry), KOH at 1.5 phr. The tensile results were satisfactory with balanced softness and modulus.

### Experiment 42

Experiment 42 was in line with experiment 41 with SLC41 cure set at 2 phr wet (0.49 dry phr); KOH level of 2 phr. With higher phr of cure set and KOH, the physical property was at its high, the unaged tensile was more than 50% of the experiment 41 results.

### Experiment 43

Experiment 43 used cure set of SLC14 at the tune of 1 phr (0.14 dry phr) and KOH at 2 phr. SLC14 contained MgO and Al₂O₃. Even at low level of curatives the film quality was good with good strength and balanced level of modulus and elongation.

### Experiment 44

Experiment 44 was in line with 43, using SLC14 with higher level of 2 phr wet (0.29 dry phr) KOH at 2 phr. The physical properties were good. The unaged results were almost same with experiment 43. However, the aged results showed higher values than the experiment 43.

### Experiment 45

Experiment 45 used cure set SLC15 at the level of 1 phr wet (0.26 phr dry); KOH at 2 phr level. In this cure set, copper sulphate was used (along with aluminium oxide) which was not used in the dipping industry for various reasons like colour contamination, toxic nature and poor shelf life. However, in this invention it was tried to prove the point of invention and the problem associated thereof. The tensile value at unaged condition was nominal but it could withstand the aging condition, the sample lost its elasticity and become plastic like and broken due to brittleness.

### Experiment 46

Experiment 46 used cure set SLC15, in line with experiment 45, but at the level of 2 phr wet (0.52 phr dry); KOH at 2 phr level. In this cure set, copper sulphate (along with aluminium oxide) was used which was not used in the dipping industry for various reasons like colour contamination, toxic nature and poor shelf life; however, in this invention it was tried to prove the point of invention and the problem associated thereof. The tensile value at unaged condition was nominal but it could withstand the aging condition, the sample lost its elasticity and become plastic like and broken due to brittleness.

### Experiment 47

In this experiment 47, cure set of SLC16 was used at 1 phr wet (0.14 phr dry); KOH 2 phr level. SLC16 contained poly ferric sulphate which is not normally used in the dipping industry (a less amount of aluminium oxide is also used) due to various compatibility issues and colour variations upon oxidation. The tensile results were good.

### Experiment 48

In this experiment 48, cure set of SLC16 was used, in line with experiment 47, but at 2 phr wet (0.28 phr dry); KOH 2 phr level. SLC16 contained poly ferric sulphate which was not normally used in the dipping industry (a less amount of aluminium oxide is also used) due to various compatibility issues and colour variations upon oxidation. The film formed was much stronger than the film obtained in experiment 47, in fact the modulus values were almost double and 10-15% increase in tensile strength. The aged film was still good unlike copper sulphate used films.

### Experiment 49

Experiment 49 used cure set of SLC17 at the tune of 1 phr wet (0.18 dry phr); KOH at 2 phr. SLC17 contained multiple polyvalent salts, oxides viz., poly ferric sulphate, copper sulphate, magnesium oxide and aluminium oxide. The unaged properties were good; however due to the presence of copper, the aged properties could not be assessed since the film lost the intended elastomeric property, the film become brittle after aging.

### Experiment 50

In line with experiment 49, experiment 50 used cure set of SLC17 at the tune of 2 phr wet (0.36 dry phr); KOH at 2 phr. SLC17 contained multiple polyvalent salts, oxides viz., poly ferric sulphate, copper sulphate, magnesium oxide and aluminium oxide. The unaged properties were good. However, due to the presence of copper, the aged properties could not be assessed since the film lost the intended elastomeric property, the film become brittle after aging. Since the cure was at 2 phr wet level, the physical properties were better and film was stronger than that of experiment 49.

### Experiment 51

Experiment 51 used SLC18 as a cure set at the tune of 1 phr wet (0.2 phr dry); KOH at 2 phr. SLC18 used aluminium sulphate salt. The physical properties were good at unaged condition. However, aged results could not be assessed due to the sample damage.

### Experiment 52

Experiment 52 used SLC19 as a cure set at the tune of 2 phr wet (0.42 phr dry); KOH at 2 phr. SLC19 used zinc sulphate and aluminium sulphate salts. The physical properties were good at unaged condition. However aged results could not be assessed due to the sample damage.

### Experiment 53

Experiment 53 used cure set SLC20 at the level of 2 phr wet (0.4 phr dry); KOH at 2 phr. In this case only ammonia was used to treat the metal oxide during cure set SLC20 preparation. The physical properties were good in both unaged and aged conditions, balanced level of strength and softness.

### Experiment 54

Experiment 54 used cure set SLC21 at the level of 2 phr wet (0.44 phr dry); KOH at 2 phr. In this case ammonia was also used along with KOH and NaOH to treat the metal oxide during cure set SLC21 preparation. The physical properties were good in both unaged and aged conditions, balanced level of strength and softness.

### Experiment 55

Experiment 55 used cure set SLC22 at the level of 1 phr wet (0.32 phr dry); KOH at 2 phr. In this case ammonia was also used along with NaOH to treat the metal oxide during cure set SLC22 preparation. The physical properties were good in both unaged and aged conditions, balanced level of strength and softness. The aged tensile and elongation values were good.

### Experiment 56

In line with experiment 55, experiment 56 used cure set SLC22 at the level of 2 phr wet (0.64 phr dry); KOH at 2 phr. In this case ammonia was also used along with NaOH to treat the metal oxide during cure set SLC22 preparation. The physical properties were good in both unaged and aged conditions, balanced level of strength and softness. The aged tensile and elongation values were good. However, compared to the experiment 55, the tensile values were not improved hence the use of additional 1 phr wet cure set was not justified. Only the modulus values were substantially high compared to experiment 55. It implies that the curing requirement for the latex is finished with 1 phr wet of cure set, the additional amount of cure set spent does not have any impact or in other words it is wasted.

### Experiment 57

In this experiment, the cure set of SLC23 was used at the tune of 1 phr wet (0.25 phr dry); KOH at the tune of 2 phr. The cure set SLC 23 contained Zinc hydroxide solely as polyvalent metal ion supplier to the crosslinking aid. The tensile results unaged and aged films were good.

### Experiment 58

Experiment 58 was in line with experiment 57. The cure set of SLC23 was used at the tune of 2 phr wet (0.5 phr dry); KOH at the tune of 2 phr. The cure set SLC 23 containing Zinc hydroxide solely as polyvalent metal ion supplier to the crosslinking aid. The tensile results unaged and aged films were good. Compared to experiment 57, there was not much change in the unaged results however marginal increase in the aged results. It seems with 1 phr wet curative the curing reaches the optimum level of crosslinking and further addition does not make much difference.

### Experiment 59

Experiment 59 used cure set SLC24 comprises three different polyvalent metals viz., magnesium oxide, zinc hydroxide and aluminium oxide. The SLC24 used was 1 phr wet (0.2 phr dry); KOH—2 phr. The physical properties were good. One of the observations was that the strength decreases after aged condition.

### Experiment 60

In line with experiment 59, experiment 60 used cure set SLC24 comprises three different polyvalent metals viz., magnesium oxide, zinc hydroxide and aluminium oxide. The SLC24 used was 2 phr wet (0.4 phr dry); KOH—2 phr. The physical properties were good. Unlike experiment 59, the property in experiment after aged condition has increased. This phenomenon is quite contradictory, exhibiting a set of behaviour at lower concentration and exhibiting opposite behaviour at higher concentration. This could be due to mixture of different polyvalent metals.

### Experiment 61

Experiment 61 was made using cure set SLC25 which comprise of zinc hydroxide and aluminium oxide. The amount of cure was 1 phr wet (0.31 phr dry); KOH—2 phr. The physical property was good with nominal tensile and higher elongation.

### Experiment 62

In line with experiment 61, experiment 62 was made using cure set SLC25. The amount of cure was 2 phr wet (0.62 phr dry); KOH—2 phr. The physical property was good with nominal tensile and higher elongation. Compared to experiment 61, the increase in modulus was substantial. As for as the cure set SLC 25 is concerned 1 phr wet is seemed to be the optimum.

### Experiment 63

Experiment 63 used cure set SLC26 comprising magnesium oxide, zinc hydroxide and aluminium oxide, the usage was 1 phr wet (0.23 phr dry); KOH—2 phr. The physical properties were good. As per the data, there was no raise in the tensile value after aging. This could be due to the multiple effect of polyvalent metal ions contributed by three different elements.

### Experiment 64

In line with experiment 63, Experiment 64 used cure set SLC26 comprising magnesium oxide, zinc hydroxide and aluminium oxide, the usage was 2 phr wet (0.45 phr dry); KOH—2 phr. The physical properties were good. As per the data there was no raise in the tensile value after aging, in fact the tensile value reduced considerably after aging. This could be due to the multiple effect of polyvalent metal ions contributed by three different elements. However due to high curative content of 2 phr initial tensile value was higher than experiment 63, and elongation was less.

### Experiment 65

In this experiment 65, cure set of SLC27 comprising magnesium oxide, zinc hydroxide and aluminium oxide. In the alkali side, potassium hydroxide, sodium hydroxide and ammonium hydroxide were used. The amount of cure set used was 1 phr wet (0.27 phr dry); KOH—2 phr. The physical property results were good with high elongation.

### Experiment 66

In line with experiment 65, experiment 66 used cure set of SLC27 comprising magnesium oxide, zinc hydroxide and aluminium oxide. In the alkali side, potassium hydroxide, sodium hydroxide and ammonium hydroxide were used. The amount of cure set used was 2 phr wet (0.54 phr dry); KOH—2 phr. The physical property results were good. However, the unaged tensile is less than the experiment 65 even though the cure set was of double amount. But the aged tensile showed substantially higher value and hence increased in the strength. On analysing SLC27 contained additional OH supplier viz., ammonium hydroxide other than that it is almost similar with SLC24 and SLC26.

### Experiment 67

Experiment 67 used SLC28 which comprising only zinc sulphate, the cure set used was 2.3 phr wet (0.52 phr dry); KOH—2.0. The tensile results were nominal. Even with high usage of salt, the tensile strength had not reached its high. This could be due to the relatively low level of Zn in the zinc sulphate salt. Apart from that, presence of sulphate radical may not be favourable to the crosslinking. Another example is the SLC9 cure set used compound.

### Experiment 68

Experiment 68 used SLC29 cure set at the tune of 2.3 phr wet (0.39 phr dry); KOH—2. The tensile values were good. However, the modulus values were very high compared to the most of previous experiments. The metallic content was too low (11.5%) hence high phr of curative was used in the experiment.

### Experiment 69

Experiment 69 used SLC30 cure set at the phr level of 1.5 wet (0.32 phr dry), KOH—2. The tensile values were good. The metallic portion was 16.2% of the SLC30 which was quite less compared to the conventional composite available in the market which varies between 50-60% TSC.

### Experiment 70

In line with experiment 69, experiment 70 used SLC30 cure set at the phr level of 3 wet (0.64 phr dry), KOH—2. The tensile values were good. The metallic portion was 16.2% of the SLC30 which was quite less compared the conventional composite available in the market which varies between 50-60% TSC. Compared to experiment 69, the aged tensile was high, modulus was quite high for both unaged and aged.

### Experiment 71

In this experiment 71, cure set of SLC19 was used at 1.5 phr wet (0.36 phr dry) level; KOH—2 phr. Silica filler of 6 phr dry was added. The physical property results were good with high and consistent tensile in both unaged and aged condition.

### Experiment 72

In line with experiment 71, cure set of SLC19 was used at 2 phr wet (0.49 phr dry) level; KOH—2 phr. In this experiment, silica filler of 12 phr dry was used, which was double the amount of experiment 71. The physical property results were good with high and consistent tensile in both unaged and aged condition and marginally higher than experiment 71.

### Experiment 73

In this experiment 73, cure set SLC31 was used, which comprising aluminium oxide sulphur and accelerator (sulphur donor). The cure set used was 1.5 phr wet (0.30 phr dry) inclusive of metal oxide and sulphur and sulphur donor. The tensile results were good, substantial rise in the tensile value after aging, and elongation was not reduced even though the modulus has raised substantially. This combination of both ionic and non-ionic curatives works well in the formation of film.

### Experiment 74

In line with experiment 73, cure set SLC31 was used, which comprising aluminium oxide sulphur and accelerator (sulphur donor). The cure set used was 2 phr wet (0.4 phr dry) inclusive of metal oxide and sulphur and sulphur donor. The tensile results were good. This combination of both ionic and non-ionic curatives worked well in the formation of film. The unaged tensile was higher than experiment 73; however, aged tensile is less than that of experiment 73.

### Experiment 75

Experiment 75 used cure set SLC32, cure set SLC32 comprising magnesium oxide, zinc hydroxide, aluminium oxide, sulphur and sulphur donor. Cure set used in the tune of 1.5 phr wet (0.38 phr dry); KOH—2 phr. Tensile results were good with good aged properties.

### Experiment 76

In line with experiment 75, cure set SLC32 was used. The cure set SLC32 comprising magnesium oxide, zinc hydroxide, aluminium oxide, sulphur and sulphur donor. Cure set used in the tune of 2 phr wet (0.5 phr dry); KOH—2 phr. Tensile results were good with good aged properties and marginally better than experiment 75, however 1.5 phr of cure set SLC32 seems to be good for all practical purposes considering commercial impact.

### Experiment 77

Experiment 77 used cure set SLC33, cure set SLC33 comprising magnesium oxide, zinc hydroxide, aluminium oxide, sulphur and sulphur donor. Cure set used in the tune of 1.5 phr wet (0.34 phr dry); KOH—2 phr. The strength of the film was good.

### Experiment 78

In line with experiment 77, cure set SLC33 comprising magnesium oxide, zinc hydroxide, aluminium oxide, sulphur and sulphur donor. Cure set used in the tune of 2 phr wet (0.45 phr dry); KOH—2 phr. The strength of the film was good and marginally better than that of experiment 77, with high modulus.

### Experiment 79

This experiment is carried out with conventional zinc oxide dispersion for comparison purpose. Experiment 79 used SLC34 cure set at the tune of 1 phr wet (0.5 phr dry). SLC 34 was the conventional cure set used only pulverization at low alkaline level say 0.25-1.0% just to make it alkaline to reach pH 9-11. The amount of cure set was 1 phr wet (0.5 phr dry); KOH—2 phr. The physical properties were just nominal resulting in soft film.

### Experiment 80

This experiment was carried out with conventional zinc oxide dispersion for comparison purpose as experiment 79. In line with experiment 79, experiment 80 used SLC34 cure set at the tune of 2 phr (1.0 phr dry), this was high compared to the cure set level of the invention. SLC 34 was the conventional cure set used only pulverization at low alkaline level say 0.25-1.0% just to make it alkaline to reach pH 9-11. The amount of cure set was 2 phr wet (1.0 phr dry); KOH—2 phr. The physical properties were nominal resulting in soft film.

### Experiment 81

This experiment was carried out with conventional zinc oxide dispersion for comparison purpose as experiment 79 and 80. In line with experiment 79 and 80, experiment 81 used SLC34 cure set at the tune of 2 phr (1.0 phr dry), this was high compared to the cure set level of the invention. SLC 34 was the conventional cure set used only pulverization at low alkaline level say 0.25-1.0% just to make it alkaline to reach pH 9-11. The amount of cure set was 2 phr wet (1.0 phr dry); KOH—2 phr. In addition to SLC34, sulphur and sulphur donor were used at the tune of 2 phr wet each. The total phr of curative was 6 phr wet (3 phr dry), which was quite high. The physical properties were good, attributed to the very high level of curatives.

### Experiment 82

Experiment 82 used cure set of SLC10 comprising aluminium oxide and zinc oxide. The amount of cure set was 2 phr wet (0.48 phr dry). In addition to that, sulphur and sulphur donor were tried in the formulation at the tune of 2 phr each. As for as the physical properties, the unaged tensile was just nominal. However, the aged tensile was high in line with experiment 81. Experiment 81 and 82 were quite similar except the cure sets one was conventional (SLC34) and another as per invention (SLC10). If we compare the aged results, both experiment 81 and experiment 82 were almost same, however the metal oxide level used in the experiment 82 was 50% less than the experiment 81, comparing to metal ion on dry basis (without considering Sulphur and Sulphur donor).

### Experiment 83

In this experiment (SLC35), the aluminium oxide was treated only with KOH for the activation purpose and no other alkali material was used. The cure level was 1 phr wet (0.156 phr dry); KOH—2.0 phr. The physical property was good and at the same time the glove was soft too. Compared to the experiment 79 of conventional cure set, experiment 83 used almost one third of the curative and achieved physical property better than that of experiment 79.

### Experiment 84

In line with the experiment 83, experiment 84 used cure set SLC35 at 2 phr wet (0.31 phr dry); KOH—2 phr. The physical property results were good, however there was no significant difference in the physical properties compared to the doubling of cure set, use of 1 phr could be the optimum level.

### Experiment 85

SLC36 comprising aluminium oxide and zinc oxide were treated only with potassium hydroxide other alkali was not incorporated. The cure set of SLC36 was at the level of 1 phr wet (0.24 phr dry). The physical property results showed nominal values. For some formulations of specific end product, use of only KOH is recommended, for such cases this will help.

### Experiment 86

In line with experiment 85, experiment 86 used cure set of SLC36 at the level of 2 phr wet (0.48 phr dry). The physical property results showed good values, and hence good film strength. For some formulations of specific end product, use of only KOH is recommended, for such cases this will help. As for as unaged condition, results were concerned both experiment 85 and experiment 86 show similar results, the effect of increasing the cure phr did not show any difference.

### Experiment 87

Experiment 87 used SLC37 cure set which was treated differently, one portion of aluminium oxide was treated with potassium hydroxide and another with sodium hydroxide and zinc oxide was treated with potassium hydroxide. SLC37 was used at 1 phr level wet (0.2 phr dry); KOH—2.0 phr. The physical properties were good, with good strength and good elongation.

### Experiment 88

Experiment 88 used SLC37 cure set which was treated differently. One portion of aluminium oxide was treated with potassium hydroxide and another with sodium hydroxide and zinc oxide was treated with potassium hydroxide. SLC37 was used at 2 phr wet (0.40 phr dry) level; KOH—2.0 phr. The physical properties were good, with good strength and good elongation. However, the film strength and toughness were higher than experiment 87.

### Experiment Results

Table 4 consolidated results of the experiments.

TABLE 4
Results of the experiments

| | | | | Force at | Tensile | M300 | M500 | Elongation |
|---|---|---|---|---|---|---|---|---|
| Experiment | Test | | Thickness | Break | Strength | Stress | Stress | at Break |
| Reference | Condition | | mm | (N) | Mpa | Mpa | MPa | % |
| 1 | Unaged | Average | 0.05 | 3.16 | 20.99 | 1.7 | 4.3 | 747 |
| | | Median | 0.05 | 3.05 | 20.27 | 1.65 | 4.28 | 740 |
| | Aged | Average | 0.05 | 3.34 | 22.14 | 1.95 | 5.55 | 720 |
| | | Median | 0.05 | 3.36 | 22.3 | 1.96 | 5.48 | 720 |
| 2 | Unaged | Average | 0.05 | 3.85 | 25.54 | 2.13 | 6.35 | 693 |
| | | Median | 0.05 | 3.81 | 25.27 | 2.15 | 6.52 | 700 |
| | Aged | Average | 0.05 | 3.78 | 25.08 | 2.47 | 7.27 | 693 |
| | | Median | 0.05 | 3.95 | 26.19 | 2.48 | 7.23 | 700 |
| 3 | Unaged | Average | 0.05 | 3.26 | 21.62 | 1.65 | 4.49 | 707 |
| | | Median | 0.05 | 3.33 | 22.09 | 1.65 | 4.57 | 700 |
| | Aged | Average | 0.05 | 3.21 | 21.31 | 2 | 5.66 | 720 |
| | | Median | 0.05 | 3.21 | 21.32 | 1.98 | 5.63 | 720 |
| 4 | Unaged | Average | 0.05 | 2.98 | 19.8 | 1.89 | 6.04 | 687 |
| | | Median | 0.05 | 2.99 | 19.82 | 1.9 | 5.88 | 680 |
| | Aged | Average | 0.05 | 4.33 | 28.75 | 2.3 | 7.4 | 713 |
| | | Median | 0.05 | 4.43 | 29.38 | 2.35 | 7.33 | 720 |
| 5 | Unaged | Average | 0.05 | 4.04 | 26.8 | 2.13 | 6.15 | 693 |
| | | Median | 0.05 | 4.01 | 26.59 | 2.14 | 6.23 | 700 |
| | Aged | Average | 0.05 | 4.02 | 26.64 | 1.85 | 4.84 | 680 |
| | | Median | 0.05 | 4.02 | 26.65 | 1.87 | 4.85 | 680 |
| 6 | Unaged | Average | 0.05 | 2.82 | 18.7 | 1.85 | 5.33 | 687 |
| | | Median | 0.05 | 2.86 | 19.01 | 1.79 | 5.48 | 680 |
| | Aged | Average | 0.05 | 3.27 | 21.72 | 1.76 | 4.5 | 640 |
| | | Median | 0.05 | 3.4 | 22.59 | 1.74 | 4.64 | 640 |
| 7 | Unaged | Average | 0.04 | 3.33 | 27.6 | 2.02 | 5.74 | 673 |
| | | Median | 0.04 | 3.35 | 27.75 | 2.05 | 5.61 | 680 |
| | Aged | Average | 0.04 | 3.03 | 25.14 | 1.93 | 4.51 | 720 |
| | | Median | 0.04 | 2.94 | 24.39 | 1.87 | 4.42 | 720 |
| 8 | Unaged | Average | 0.04 | 4 | 33.16 | 2.54 | 8.02 | 667 |
| | | Median | 0.04 | 3.37 | 32.11 | 2.53 | 7.94 | 660 |
| | Aged | Average | 0.04 | 3.36 | 27.87 | 3 | 10.49 | 680 |
| | | Median | 0.04 | 3.43 | 28.47 | 2.97 | 10.42 | 680 |
| 9 | Unaged | Average | 0.05 | 3.09 | 20.48 | 1.82 | 5.03 | 713 |
| | | Median | 0.05 | 3.13 | 20.76 | 1.81 | 4.68 | 720 |
| | Aged | Average | 0.05 | 3.89 | 25.78 | 2.15 | 6.82 | 680 |
| | | Median | 0.05 | 3.89 | 25.81 | 2.24 | 6.93 | 680 |
| 10 | Unaged | Average | 0.05 | 3.69 | 24.5 | 2.7 | 7.69 | 640 |
| | | Median | 0.05 | 3.75 | 24.88 | 2.68 | 7.58 | 660 |
| | Aged | Average | 0.05 | 4.11 | 27.26 | 2.79 | 9.84 | 660 |
| | | Median | 0.05 | 4.13 | 27.4 | 2.87 | 10.66 | 660 |
| 11 | Unaged | Average | 0.04 | 4.04 | 33.5 | 3.2 | 9.83 | 687 |
| | | Median | 0.04 | 3.94 | 32.67 | 3.21 | 10.4 | 700 |
| | Aged | Average | 0.04 | 3.74 | 31.01 | 2.89 | 9.49 | 630 |
| | | Median | 0.04 | 3.74 | 31.01 | 2.89 | 9.49 | 630 |
| 12 | Unaged | Average | 0.05 | 4.04 | 26.8 | 3.1 | 10.51 | 640 |
| | | Median | 0.05 | 4.07 | 26.99 | 3.18 | 10.54 | 640 |
| | Aged | Average | 0.05 | 4.9 | 32.53 | 3.94 | 16.56 | 633 |
| | | Median | 0.05 | 5.91 | 32.61 | 3.96 | 16.14 | 640 |
| 13 | Unaged | Average | 0.05 | 3.55 | 23.54 | 1.62 | 4.58 | 740 |
| | | Median | 0.05 | 3.49 | 23.15 | 1.58 | 4.64 | 740 |
| | Aged | Average | 0.05 | 3.4 | 22.59 | 1.58 | 4.23 | 720 |
| | | Median | 0.05 | 3.31 | 21.96 | 1.54 | 4.09 | 720 |
| 14(2.8 g) | Unaged | Average | 0.05 | 3.7 | 24.59 | 2.53 | 8.67 | 640 |
| | | Median | 0.05 | 4.18 | 27.75 | 2.49 | 8.86 | 640 |
| | Aged | Average | 0.05 | 2.91 | 19.31 | 1.77 | 4.75 | 687 |
| | | Median | 0.05 | 3.06 | 20.29 | 1.74 | 4.58 | 700 |
| 14(3.3 g) | Unaged | Average | 0.06 | 5.6 | 30.96 | 2.29 | 7.64 | 680 |
| | | Median | 0.06 | 5.52 | 30.54 | 2.25 | 7.64 | 680 |
| | Aged | Average | 0.06 | 4.52 | 24.97 | 2.15 | 6.81 | 680 |
| | | Median | 0.06 | 4.71 | 26.04 | 2.16 | 6.64 | 680 |
| 15 | Unaged | Average | 0.06 | 3.63 | 20.07 | 1.46 | 3.21 | 740 |
| | | Median | 0.06 | 3.9 | 21.57 | 1.45 | 3.28 | 760 |
| | Aged | Average | 0.06 | 4.9 | 27.09 | 1.76 | 4.76 | 687 |
| | | Median | 0.06 | 4.9 | 27.1 | 1.76 | 4.81 | 700 |
| 16 | Unaged | Average | 0.06 | 5.83 | 32.24 | 2.99 | 10.6 | 667 |
| | | Median | 0.06 | 5.2 | 28.76 | 2.94 | 10.3 | 660 |
| | Aged | Average | 0.06 | 7.11 | 39.32 | 3.09 | 9.58 | 690 |
| | | Median | 0.06 | 7.11 | 39.32 | 3.09 | 9.58 | 690 |
| 17 | Unaged | Average | 0.06 | 3.35 | 18.53 | 1.35 | 2.9 | 753 |
| | | Median | 0.06 | 3.31 | 18.33 | 1.35 | 2.82 | 740 |
| | Aged | Average | 0.06 | 3.96 | 21.88 | 1.92 | 4.82 | 713 |
| | | Median | 0.06 | 4.15 | 22.95 | 1.96 | 4.8 | 720 |
| 18 | Unaged | Average | 0.06 | 5.33 | 29.5 | 2.06 | 5 | 700 |
| | | Median | 0.06 | 4.83 | 26.73 | 1.94 | 5.01 | 700 |
| | Aged | Average | 0.06 | 6.07 | 33.54 | 3.06 | 9.96 | 660 |
| | | Median | 0.06 | 6.07 | 33.54 | 3.06 | 9.96 | 660 |
| 19 | Unaged | Average | 0.06 | 5.86 | 32.41 | 2.75 | 7.38 | 687 |
| | | Median | 0.06 | 5.55 | 30.68 | 2.52 | 7.41 | 680 |
| | Aged | Average | 0.06 | 8 | 44.23 | 3.53 | 12.86 | 667 |
| | | Median | 0.06 | 7.4 | 40.93 | 3.39 | 12.71 | 660 |
| 20 | Unaged | Average | 0.06 | 6.68 | 36.93 | 2.92 | 8.24 | 687 |
| | | Median | 0.06 | 6.91 | 38.21 | 2.9 | 8.41 | 680 |
| | Aged | Average | 0.06 | 9.43 | 52.14 | 4.07 | 15.5 | 673 |
| | | Median | 0.06 | 9.54 | 52.77 | 4.08 | 14.06 | 680 |
| 21 | Unaged | Average | 0.06 | 6.3 | 33.1 | 2.89 | 10.19 | 680 |
| | | Median | 0.06 | 6.38 | 32.32 | 2.76 | 9.91 | 680 |
| | Aged | Average | 0.06 | 8.14 | 45.04 | 4.13 | 15.68 | 667 |
| | | Median | 0.06 | 8.02 | 44.36 | 4.21 | 15.9 | 660 |
| 22 | Unaged | Average | 0.06 | 6.52 | 36.08 | 3.26 | 12.05 | 680 |
| | | Median | 0.06 | 6.47 | 35.82 | 3.18 | 12.26 | 680 |
| | Aged | Average | 0.06 | 8.92 | 49.33 | 4.24 | 16.45 | 680 |
| | | Median | 0.06 | 9.25 | 51.19 | 4.21 | 15.9 | 680 |
| 23 | Unaged | Average | 0.05 | 5.79 | 38.42 | 2.79 | 9.64 | 720 |
| | | Median | 0.05 | 5.77 | 38.27 | 2.85 | 9.77 | 720 |
| | Aged | Average | 0.06 | 6.27 | 34.71 | 2.92 | 12 | 680 |
| | | Median | 0.06 | 6.24 | 34.54 | 2.85 | 12.11 | 680 |
| 24 | Unaged | Average | 0.05 | 7.31 | 48.53 | 4.21 | 16.55 | 687 |
| | | Median | 0.05 | 7.37 | 48.93 | 4.29 | 16.25 | 680 |
| | Aged | Average | 0.06 | 8.06 | 44.6 | 3.5 | 14.49 | 687 |
| | | Median | 0.06 | 7.66 | 42.4 | 3.53 | 14.62 | 680 |
| 25 | Unaged | Average | 0.06 | 6.92 | 38.29 | 3.54 | 13.82 | 667 |
| | | Median | 0.06 | 6.5 | 35.97 | 3.57 | 13.98 | 660 |
| | Aged | Average | 0.06 | 7.51 | 20.83 | 2.03 | 8.27 | 640 |
| | | Median | 0.06 | 7.51 | 20.83 | 2.03 | 8.27 | 640 |
| 26 | Unaged | Average | 0.06 | 7.77 | 42.96 | 4.03 | 15.91 | 660 |
| | | Median | 0.06 | 7.81 | 43.19 | 3.98 | 15.89 | 660 |
| | Aged | Average | 0.06 | 8.09 | 22.41 | 2 | 7.8 | 667 |
| | | Median | 0.06 | 8.19 | 22.68 | 1.97 | 7.6 | 660 |
| 27 | Unaged | Average | 0.06 | 6.6 | 36.53 | 2.57 | 7.83 | 707 |
| | | Median | 0.06 | 6.59 | 36.45 | 2.58 | 7.77 | 700 |
| | Aged | Average | 0.06 | 6.07 | 33.6 | 2.92 | 11.06 | 653 |
| | | Median | 0.06 | 5.65 | 31.25 | 2.93 | 11.47 | 640 |
| 28 | Unaged | Average | 0.06 | 6.78 | 37.52 | 2.54 | 7.89 | 700 |
| | | Median | 0.06 | 6.82 | 37.74 | 2.5 | 7.88 | 700 |
| | Aged | Average | 0.06 | 6.84 | 37.82 | 3.08 | 11.09 | 673 |
| | | Median | 0.06 | 6.76 | 37.37 | 3.22 | 11.01 | 680 |
| 29 | Unaged | Average | 0.06 | 5.04 | 27.86 | 2 | 5.4 | 720 |
| | | Median | 0.06 | 4.84 | 27.32 | 1.99 | 5.28 | 720 |
| | Aged | Average | 0.06 | 5.41 | 28.4 | 1.89 | 5.6 | 707 |
| | | Median | 0.06 | 5.43 | 28.19 | 1.86 | 5.58 | 700 |
| 30 | Unaged | Average | 0.06 | 4.77 | 26.37 | 2.4 | 7.02 | 673 |
| | | Median | 0.06 | 5.02 | 27.75 | 2.36 | 7 | 680 |
| | Aged | Average | 0.06 | 5.82 | 32.21 | 2.28 | 6.89 | 687 |
| | | Median | 0.06 | 5.69 | 31.5 | 2.32 | 6.43 | 680 |
| 31 | Unaged | Average | 0.06 | 3.95 | 21.86 | 1.43 | 3.23 | 740 |
| | | Median | 0.06 | 3.93 | 21.77 | 1.41 | 3.25 | 740 |
| | Aged | Average | 0.06 | 3.89 | 21.52 | 1.84 | 4.77 | 700 |
| | | Median | 0.06 | 3.93 | 21.75 | 1.86 | 4.72 | 700 |
| 32 | Unaged | Average | 0.06 | 4.47 | 24.7 | 1.68 | 4.19 | 727 |
| | | Median | 0.06 | 4.53 | 25.07 | 1.63 | 4.07 | 720 |
| | Aged | Average | 0.06 | 5.52 | 30.53 | 2.13 | 6.39 | 700 |
| | | Median | 0.06 | 5.51 | 30.49 | 2.12 | 6.25 | 700 |
| 33 | Unaged | Average | 0.06 | 3.4 | 18.8 | 1.3 | 2.44 | 793 |
| | | Median | 0.06 | 3.35 | 18.54 | 1.27 | 2.42 | 780 |
| | Aged | Average | 0.06 | 4.28 | 23.67 | 1.38 | 3.27 | 760 |
| | | Median | 0.06 | 4.11 | 22.74 | 1.38 | 3.24 | 760 |
| 34 | Unaged | Average | 0.06 | 4.45 | 24.63 | 1.39 | 3.17 | 760 |
| | | Median | 0.06 | 4.39 | 24.28 | 1.39 | 3.09 | 760 |
| | Aged | Average | 0.06 | 4.12 | 22.79 | 1.48 | 3.44 | 740 |
| | | Median | 0.06 | 3.84 | 21.24 | 1.54 | 3.48 | 740 |
| 35 | Unaged | Average | 0.06 | 4.55 | 25.16 | 1.58 | 4.06 | 740 |
| | | Median | 0.06 | 4.38 | 24.24 | 1.51 | 3.83 | 740 |
| | Aged | Average | 0.06 | 4.77 | 26.4 | 1.77 | 5.23 | 693 |
| | | Median | 0.06 | 4.68 | 25.9 | 1.83 | 4.81 | 680 |
| 36 | Unaged | Average | 0.06 | 6.2 | 34.28 | 2.72 | 9.46 | 693 |
| | | Median | 0.06 | 6.2 | 34.31 | 2.69 | 9.51 | 700 |
| | Aged | Average | 0.06 | 5.88 | 34.51 | 2.96 | 12.14 | 633 |
| | | Median | 0.06 | 5.9 | 35.15 | 2.79 | 11.95 | 640 |
| 37 | Unaged | Average | 0.06 | 4.12 | 24.07 | 1.56 | 3.59 | 740 |
| | | Median | 0.06 | 4.42 | 24.43 | 1.51 | 3.67 | 740 |
| | Aged | Average | 0.05 | 3.88 | 25.71 | 1.87 | 4.82 | 700 |
| | | Median | 0.05 | 3.88 | 25.71 | 1.87 | 4.82 | 700 |
| 38 | Unaged | Average | 0.06 | 5.35 | 29.62 | 2.27 | 7.66 | 680 |
| | | Median | 0.06 | 5.44 | 30.11 | 2.27 | 7.67 | 680 |
| | Aged | Average | 0.06 | 4.95 | 27.36 | 2.43 | 8.68 | 650 |
| | | Median | 0.06 | 4.95 | 27.36 | 2.43 | 8.68 | 650 |
| 39 | Unaged | Average | 0.06 | 3.72 | 20.57 | 1.15 | 2.66 | 760 |
| | | Median | 0.06 | 3.74 | 20.69 | 1.22 | 2.78 | 760 |
| | Aged | Average | 0.06 | 3.99 | 22.1 | 1.67 | 4.16 | 700 |
| | | Median | 0.06 | 4.04 | 22.37 | 1.66 | 4.2 | 700 |
| 40 | Unaged | Average | 0.06 | 5.44 | 30.09 | 2.15 | 6.7 | 713 |
| | | Median | 0.06 | 5.49 | 30.37 | 2.26 | 6.63 | 720 |
| | Aged | Average | 0.06 | 5.34 | 29.53 | 2.19 | 6.51 | 673 |
| | | Median | 0.06 | 5.33 | 29.48 | 2.18 | 6.43 | 680 |
| 41 | Unaged | Average | 0.06 | 4.63 | 25.6 | 2.01 | 4.94 | 713 |
| | | Median | 0.06 | 4.58 | 25.32 | 2.03 | 5.07 | 720 |
| | Aged | Average | 0.06 | 4.89 | 27.06 | 1.85 | 5.39 | 687 |
| | | Median | 0.06 | 4.98 | 27.53 | 1.88 | 5.43 | 680 |
| 42 | Unaged | Average | 0.05 | 6.14 | 40.74 | 4.6 | 17.41 | 640 |
| | | Median | 0.05 | 6.06 | 40.23 | 4.48 | 17.48 | 640 |
| | Aged | Average | 0.06 | 6.82 | 37.74 | 3.49 | 14.03 | 647 |
| | | Median | 0.06 | 6.75 | 37.36 | 3.56 | 14.16 | 640 |
| 43 | Unaged | Average | 0.06 | 5.49 | 30.36 | 2.21 | 7.39 | 687 |
| | | Median | 0.06 | 5.49 | 30.37 | 2.19 | 7.21 | 680 |
| | Aged | Average | 0.06 | 5.27 | 29.16 | 2.28 | 7.4 | 673 |
| | | Median | 0.06 | 5.42 | 29.98 | 2.28 | 7.27 | 680 |
| 44 | Unaged | Average | 0.06 | 5.47 | 30.27 | 3.04 | 10.19 | 667 |
| | | Median | 0.06 | 5.58 | 30.89 | 3.07 | 10.31 | 660 |
| | Aged | Average | 0.06 | 6.96 | 38.49 | 3.42 | 14.04 | 653 |
| | | Median | 0.06 | 6.75 | 37.34 | 3.45 | 14.53 | 660 |
| 45 | Unaged | Average | 0.06 | 4.02 | 22.21 | 1.49 | 3.72 | 720 |
| | | Median | 0.06 | 4.09 | 22.6 | 1.49 | 3.73 | 720 |
| | Aged | Average | Sample Spoilt | | | | | |
| | | Median | | | | | | |
| 46 | Unaged | Average | 0.06 | 5.17 | 28.6 | 2.25 | 7.07 | 673 |
| | | Median | 0.06 | 5.12 | 28.3 | 2.26 | 7.12 | 680 |
| | Aged | Average | Sample Spoilt | | | | | |
| | | Median | | | | | | |
| 47 | Unaged | Average | 0.06 | 4.88 | 27 | 2.04 | 7.3 | 687 |
| | | Median | 0.06 | 4.69 | 25.93 | 2.1 | 7.37 | 680 |
| | Aged | Average | 0.06 | 5.79 | 31.99 | 2.04 | 7.14 | 673 |
| | | Median | 0.06 | 5.74 | 31.73 | 2.03 | 7.06 | 680 |
| 48 | Unaged | Average | 0.06 | 5.4 | 29.88 | 3.17 | 12.08 | 660 |
| | | Median | 0.06 | 5.38 | 29.78 | 3.24 | 12.63 | 660 |
| | Aged | Average | 0.06 | 6.46 | 35.72 | 3.58 | 14.9 | 620 |
| | | Median | 0.06 | 6.62 | 36.6 | 3.58 | 15.07 | 620 |
| 49 | Unaged | Average | 0.06 | 5.79 | 32.03 | 1.99 | 6.01 | 693 |
| | | Median | 0.06 | 5.93 | 32.8 | 2.01 | 6 | 700 |
| | Aged | Average | Sample Spoilt | | | | | |
| | | Median | | | | | | |
| 50 | Unaged | Average | 0.05 | 5.79 | 38.47 | 3.6 | 13.87 | 633 |
| | | Median | 0.05 | 5.81 | 38.57 | 3.65 | 12.79 | 640 |
| | Aged | Average | Sample Spoilt | | | | | |
| | | Median | | | | | | |
| 51 | Unaged | Average | 0.05 | 4.92 | 32.68 | 1.8 | 4.34 | 733 |
| | | Median | 0.05 | 4.77 | 31.67 | 1.87 | 4.51 | 720 |
| | Aged | Average | Sample Spoilt | | | | | |
| | | Median | | | | | | |
| 52 | Unaged | Average | 0.06 | 4.81 | 26.61 | 1.74 | 4.23 | 707 |
| | | Median | 0.06 | 5.03 | 27.83 | 1.69 | 4.27 | 700 |
| | Aged | Average | Sample Spoilt | | | | | |
| | | Median | | | | | | |
| 53 | Unaged | Average | 0.06 | 5.45 | 30.14 | 1.69 | 4.37 | 713 |
| | | Median | 0.06 | 5.48 | 30.32 | 1.68 | 4.45 | 700 |
| | Aged | Average | 0.06 | 6.13 | 33.89 | 2.39 | 8.28 | 720 |
| | | Median | 0.06 | 6.26 | 34.62 | 2.37 | 8.3 | 720 |
| 54 | Unaged | Average | 0.06 | 5.35 | 29.6 | 2.01 | 5.35 | 700 |
| | | Median | 0.06 | 5.39 | 29.8 | 1.98 | 5.4 | 700 |
| | Aged | Average | 0.06 | 5 | 27.65 | 2.15 | 6.11 | 700 |
| | | Median | 0.06 | 5 | 27.65 | 2.15 | 6.11 | 700 |
| 55 | Unaged | Average | 0.06 | 5.71 | 31.59 | 2.77 | 8.27 | 687 |
| | | Median | 0.06 | 5.78 | 32 | 2.77 | 8.05 | 680 |
| | Aged | Average | 0.06 | 7.41 | 41.02 | 3.09 | 10.55 | 713 |
| | | Median | 0.06 | 7.37 | 40.79 | 3.19 | 10.99 | 720 |
| 56 | Unaged | Average | 0.06 | 5.63 | 31.14 | 3.84 | 12.79 | 653 |
| | | Median | 0.06 | 5.86 | 32.39 | 3.91 | 12.55 | 660 |
| | Aged | Average | 0.06 | 6.9 | 38.17 | 4.9 | 17.44 | 660 |
| | | Median | 0.06 | 7.22 | 39.33 | 4.84 | 17.71 | 660 |
| 57 | Unaged | Average | 0.06 | 5.11 | 28.29 | 1.75 | 4.66 | 720 |
| | | Median | 0.06 | 5.02 | 27.78 | 1.77 | 4.89 | 720 |
| | Aged | Average | 0.06 | 6.01 | 33.28 | 2.51 | 8.45 | 687 |
| | | Median | 0.06 | 6.08 | 33.65 | 2.45 | 8.56 | 680 |
| 58 | Unaged | Average | 0.06 | 4.81 | 26.59 | 1.95 | 5.29 | 700 |
| | | Median | 0.06 | 4.83 | 26.72 | 1.9 | 5.04 | 700 |
| | Aged | Average | 0.07 | 7.47 | 37.09 | 2.93 | 11.65 | 673 |
| | | Median | 0.07 | 7.85 | 37.22 | 2.89 | 11.48 | 680 |
| 59 | Unaged | Average | 0.06 | 5.98 | 33.09 | 2.4 | 8.43 | 707 |
| | | Median | 0.06 | 6.43 | 35.55 | 2.33 | 8.36 | 720 |
| | Aged | Average | 0.06 | 5.59 | 30.93 | 1.88 | 5.28 | 700 |
| | | Median | 0.06 | 5.63 | 31.11 | 1.72 | 4.83 | 690 |
| 60 | Unaged | Average | 0.06 | 5.63 | 31.15 | 3.36 | 12.91 | 640 |
| | | Median | 0.06 | 5.66 | 31.29 | 3.39 | 12.76 | 640 |
| | Aged | Average | 0.06 | 6.48 | 35.86 | 2.25 | 6.83 | 687 |
| | | Median | 0.06 | 6.5 | 35.96 | 2.18 | 7 | 680 |
| 61 | Unaged | Average | 0.05 | 4.15 | 25.87 | 1.66 | 4.41 | 720 |
| | | Median | 0.05 | 4.05 | 25.42 | 1.61 | 4.33 | 720 |
| | Aged | Average | 0.06 | 5.09 | 28.17 | 2.09 | 6.62 | 660 |
| | | Median | 0.06 | 5.25 | 29.02 | 2.11 | 6.52 | 660 |
| 62 | Unaged | Average | 0.05 | 4.31 | 28.84 | 2.46 | 8 | 660 |
| | | Median | 0.05 | 4.17 | 27.69 | 2.53 | 8.28 | 660 |
| | Aged | Average | 0.05 | 4.46 | 29.64 | 3.55 | 12.55 | 627 |
| | | Median | 0.05 | 4.22 | 28.04 | 3.65 | 12.33 | 620 |
| 63 | Unaged | Average | 0.05 | 4.76 | 31.59 | 2.3 | 7.57 | 680 |
| | | Median | 0.05 | 4.8 | 31.84 | 2.3 | 7.68 | 680 |
| | Aged | Average | 0.06 | 5.27 | 29.17 | 2.08 | 6.56 | 667 |
| | | Median | 0.06 | 5.54 | 30.66 | 2.12 | 6.55 | 660 |
| 64 | Unaged | Average | 0.05 | 5.75 | 38.18 | 3.39 | 13.43 | 647 |
| | | Median | 0.05 | 5.81 | 38.6 | 3.43 | 13.33 | 640 |
| | Aged | Average | 0.06 | 5.03 | 27.81 | 2.96 | 11.58 | 613 |
| | | Median | 0.06 | 5.13 | 28.4 | 2.92 | 11.86 | 620 |
| 65 | Unaged | Average | 0.05 | 4.48 | 29.77 | 2.35 | 8.09 | 707 |
| | | Median | 0.05 | 4.73 | 31.39 | 2.43 | 8.06 | 700 |
| | Aged | Average | 0.06 | 5.32 | 29.41 | 2.03 | 6.36 | 680 |
| | | Median | 0.06 | 4.99 | 27.48 | 2.09 | 6.25 | 680 |
| 66 | Unaged | Average | 0.06 | 4.88 | 26.98 | 3.13 | 12.15 | 633 |
| | | Median | 0.06 | 5.02 | 27.77 | 3.09 | 12.38 | 640 |
| | Aged | Average | 0.05 | 6.18 | 38.31 | 3.76 | 13.9 | 633 |
| | | Median | 0.05 | 5.98 | 39.7 | 3.79 | 13.6 | 640 |
| 67 | Unaged | Average | 0.06 | 4.25 | 23.52 | 1.81 | 5.38 | 660 |
| | | Median | 0.06 | 4.44 | 24.58 | 1.84 | 5.23 | 660 |
| | Aged | Average | 0.05 | 3.91 | 25.97 | 2.21 | 6.71 | 660 |
| | | Median | 0.05 | 3.91 | 25.97 | 2.21 | 6.71 | 660 |
| 68 | Unaged | Average | 0.05 | 5.31 | 35.5 | 4.36 | 19.01 | 607 |
| | | Median | 0.05 | 5.37 | 35.68 | 4.34 | 19.2 | 600 |
| | Aged | Average | 0.06 | 5.76 | 31.87 | 3.71 | 16.32 | 627 |
| | | Median | 0.06 | 5.7 | 31.52 | 3.76 | 16.13 | 620 |
| 69 | Unaged | Average | 0.05 | 5.53 | 36.7 | 3.22 | 11.99 | 660 |
| | | Median | 0.05 | 5.76 | 38.22 | 3.26 | 11.87 | 660 |
| | Aged | Average | 0.05 | 6.38 | 42.37 | 3.39 | 14.75 | 680 |
| | | Median | 0.05 | 6.28 | 41.71 | 3.64 | 14.57 | 680 |
| 70 | Unaged | Average | 0.06 | 6.73 | 37.23 | 4.43 | 19.48 | 640 |
| | | Median | 0.06 | 6.7 | 37.07 | 4.42 | 19.38 | 640 |
| | Aged | Average | 0.05 | 7.18 | 47.68 | 4.99 | 22.59 | 653 |
| | | Median | 0.05 | 7.3 | 48.44 | 5.01 | 22.58 | 660 |
| 71 | Unaged | Average | 0.06 | 6.24 | 34.56 | 3.87 | 14.15 | 673 |
| | | Median | 0.06 | 6.1 | 33.77 | 3.84 | 14.11 | 680 |
| | Aged | Average | 0.06 | 6.35 | 35.12 | 3.56 | 13.38 | 633 |
| | | Median | 0.06 | 6.42 | 35.52 | 3.64 | 13.28 | 640 |
| 72 | Unaged | Average | 0.06 | 6.18 | 34.17 | 4.85 | 17.24 | 613 |
| | | Median | 0.06 | 6.59 | 36.46 | 4.83 | 17.29 | 620 |
| | Aged | Average | 0.06 | 6.97 | 38.59 | 4.79 | 16.95 | 627 |
| | | Median | 0.06 | 6.68 | 36.98 | 4.68 | 17.9 | 620 |
| 73 | Unaged | Average | 0.06 | 5.82 | 32.22 | 2.78 | 9.74 | 660 |
| | | Median | 0.06 | 5.95 | 32.93 | 2.75 | 10.07 | 660 |
| | Aged | Average | 0.06 | 7.7 | 42.59 | 3.71 | 14.28 | 693 |
| | | Median | 0.06 | 8.03 | 44.4 | 3.55 | 14.76 | 700 |
| 74 | Unaged | Average | 0.06 | 7.09 | 39.23 | 3.53 | 13.44 | 647 |
| | | Median | 0.06 | 6.82 | 37.72 | 3.38 | 13.31 | 640 |
| | Aged | Average | 0.06 | 6.99 | 38.66 | 3.9 | 15.1 | 680 |
| | | Median | 0.06 | 7.04 | 38.92 | 4.04 | 15.78 | 680 |
| 75 | Unaged | Average | 0.06 | 6.65 | 36.81 | 2.59 | 8.8 | 687 |
| | | Median | 0.06 | 6.77 | 37.47 | 2.63 | 9.16 | 680 |
| | Aged | Average | 0.06 | 6.98 | 38.62 | 3.46 | 12.88 | 647 |
| | | Median | 0.06 | 7.16 | 39.62 | 3.43 | 12.97 | 640 |
| 76 | Unaged | Average | 0.06 | 7.12 | 39.36 | 2.81 | 8.9 | 693 |
| | | Median | 0.06 | 6.96 | 38.48 | 2.8 | 8.69 | 700 |
| | Aged | Average | 0.06 | 7.63 | 42.22 | 3.72 | 13.28 | 700 |
| | | Median | 0.06 | 7.72 | 42.69 | 3.86 | 13.18 | 700 |
| 77 | Unaged | Average | 0.05 | 5.01 | 33.28 | 2.36 | 7.95 | 707 |
| | | Median | 0.05 | 5.03 | 33.42 | 2.37 | 7.86 | 700 |
| | Aged | Average | 0.06 | 5.61 | 31.06 | 2.23 | 7.47 | 680 |
| | | Median | 0.06 | 5.75 | 31.83 | 2.17 | 7.46 | 680 |
| 78 | Unaged | Average | 0.05 | 5.11 | 33.96 | 3.64 | 12.92 | 660 |
| | | Median | 0.05 | 5.07 | 33.68 | 3.65 | 12.71 | 660 |
| | Aged | Average | 0.06 | 6.12 | 33.85 | 2.72 | 9.88 | 673 |
| | | Median | 0.06 | 6.24 | 34.52 | 2.88 | 10.28 | 680 |
| 79 | Unaged | Average | 0.05 | 3.44 | 22.84 | 1.41 | 2.87 | 780 |
| | | Median | 0.05 | 3.41 | 22.66 | 1.42 | 2.82 | 800 |
| | Aged | Average | 0.06 | 3.66 | 20.25 | 1.33 | 3.02 | 760 |
| | | Median | 0.06 | 3.6 | 19.94 | 1.37 | 3.21 | 760 |
| 80 | Unaged | Average | 0.06 | 4.79 | 26.51 | 1.81 | 4.95 | 720 |
| | | Median | 0.06 | 4.58 | 25.33 | 1.81 | 4.98 | 720 |
| | Aged | Average | 0.06 | 3.95 | 21.86 | 1.87 | 4.79 | 667 |
| | | Median | 0.06 | 3.9 | 21.59 | 1.87 | 4.83 | 660 |
| 81 | Unaged | Average | 0.06 | 4.83 | 28.22 | 3.06 | 12.56 | 620 |
| | | Median | 0.06 | 5.14 | 28.41 | 3.05 | 12.94 | 620 |
| | Aged | Average | 0.05 | 5.9 | 36.75 | 5.59 | 34.23 | 520 |
| | | Median | 0.05 | 5.57 | 36.64 | 5.64 | 34.21 | 520 |
| 82 | Unaged | Average | 0.05 | 3.38 | 22.4 | 3.2 | 12.01 | 607 |
| | | Median | 0.05 | 3.37 | 22.35 | 3.03 | 12.23 | 600 |
| | Aged | Average | 0.05 | 5.42 | 35.96 | 5.89 | 33.79 | 520 |
| | | Median | 0.05 | 5.57 | 36.98 | 5.8 | 34.53 | 520 |
| 83 | Unaged | Average | 0.05 | 3.95 | 26.22 | 1.57 | 3.7 | 760 |
| | | Median | 0.05 | 3.88 | 25.77 | 1.54 | 3.63 | 760 |
| | Aged | Average | 0.05 | 4.49 | 29.83 | 1.95 | 5.12 | 733 |
| | | Median | 0.05 | 4.51 | 29.92 | 1.94 | 5.48 | 740 |
| 84 | Unaged | Average | 0.05 | 4.16 | 27.59 | 1.7 | 3.94 | 760 |
| | | Median | 0.05 | 4.16 | 27.63 | 1.7 | 3.91 | 760 |
| | Aged | Average | 0.05 | 4.66 | 30.9 | 2.06 | 5.7 | 733 |
| | | Median | 0.05 | 4.51 | 29.92 | 2.1 | 5.61 | 740 |
| 85 | Unaged | Average | 0.05 | 4.13 | 27.43 | 2.01 | 5.44 | 767 |
| | | Median | 0.05 | 4.22 | 28.03 | 1.98 | 5.46 | 760 |
| | Aged | Average | 0.05 | 3.02 | 20.03 | 1.91 | 4.98 | 650 |
| | | Median | 0.05 | 3.02 | 20.03 | 1.91 | 4.98 | 650 |
| 86 | Unaged | Average | 0.05 | 4.06 | 26.93 | 2.43 | 7.43 | 680 |
| | | Median | 0.05 | 4.24 | 28.18 | 2.46 | 7.42 | 680 |
| | Aged | Average | 0.05 | 4.99 | 33.13 | 2.41 | 7.41 | 693 |
| | | Median | 0.05 | 5 | 33.2 | 2.52 | 7.5 | 700 |
| 87 | Unaged | Average | 0.05 | 4.74 | 31.43 | 2.09 | 5.65 | 720 |
| | | Median | 0.05 | 4.59 | 30.44 | 2.08 | 5.71 | 720 |
| | Aged | Average | 0.06 | 5.22 | 28.86 | 2.04 | 6.21 | 707 |
| | | Median | 0.06 | 5.22 | 28.88 | 2.06 | 6.2 | 700 |
| 88 | Unaged | Average | 0.05 | 5.02 | 33.31 | 2.94 | 8.3 | 627 |
| | | Median | 0.05 | 4.89 | 32.43 | 2.91 | 8.3 | 620 |
| | Aged | Average | 0.05 | 5.2 | 34.5 | 3.17 | 10.97 | 633 |
| | | Median | 0.05 | 5.12 | 33.97 | 3.18 | 11.14 | 640 |

### Crisscross Analysis of Strength

Table 5 illustrates the phr of various cure-sets arranged in the ascending order and the respective experiment number, KOH and Cure phr in the compound, and the strength properties reported accordingly to the relevant experiment. Metal ion contribution is considered for tabulation, the usage of sulphur and sulphur donors are limited to small number of experiments.

TABLE 5
Strength with respect to the cure-set and phr

| Cure | EXP | | Cure | % | Dry | TS | TS |
|---|---|---|---|---|---|---|---|
| set | no. | KOH | phr-wet | cure | phr | Unaged | Aged |
| SLC2 | 3 | 1.5 | 1 | 11.5 | 0.11 | 22.09 | 21.32 |
| SLC16 | 47 | 2 | 1 | 13.7 | 0.14 | 25.93 | 31.73 |
| SLC14 | 43 | 2 | 1 | 14.3 | 0.14 | 30.37 | 29.98 |
| SLC2 | 6 | 1.5 | 1.3 | 11.5 | 0.15 | 19.01 | 22.59 |
| SLC35 | 83 | 2 | 1 | 15.6 | 0.16 | 25.77 | 29.92 |
| SLC2 | 5 | 1.5 | 1.5 | 11.5 | 0.17 | 26.59 | 26.65 |
| SLC17 | 49 | 2 | 1 | 18.1 | 0.18 | 32.8 | |
| SLCA8 | 13 | 2 | 1 | 19.0 | 0.19 | 23.15 | 22.59 |
| SLC1 | 4 | 1.5 | 1.3 | 14.7 | 0.19 | 19.82 | 29.38 |
| SLC24 | 59 | 2 | 1 | 19.7 | 0.20 | 35.55 | 31.11 |
| SLC37 | 87 | 2 | 1 | 20.0 | 0.20 | 30.44 | 28.88 |
| SLC18 | 51 | 2 | 1 | 20.0 | 0.20 | 31.67 | |
| SLC7 | 29 | 2 | 1 | 22.0 | 0.22 | 27.8 | 28.19 |
| SLC8 | 31 | 1.5 | 1 | 22.0 | 0.22 | 21.77 | 21.75 |
| SLC9 | 33 | 1.5 | 1 | 22.0 | 0.22 | 18.54 | 22.74 |
| SLC1 | 1 | 0.8 | 1.5 | 14.7 | 0.22 | 20.27 | 22.3 |
| SLC1 | 2 | 1.5 | 1.5 | 14.7 | 0.22 | 25.27 | 26.19 |
| SLC26 | 63 | 2 | 1 | 22.6 | 0.23 | 31.84 | 30.66 |
| SLC12 | 37 | 1.5 | 1 | 23.2 | 0.23 | 24.43 | 25.7 |
| SLC13 | 39 | 1.5 | 1 | 23.2 | 0.23 | 20.69 | 22.37 |
| SLC4 | 11 | 2 | 1 | 24.3 | 0.24 | 32.67 | 31.01 |
| SLC6 | 27 | 1.5 | 1 | 24.3 | 0.24 | 36.45 | 33.6 |
| SLC11 | 35 | 1.5 | 1 | 24.3 | 0.24 | 24.24 | 25.9 |
| SLC10 | 41 | 1.5 | 1 | 24.3 | 0.24 | 25.32 | 27.53 |
| SLC36 | 85 | 2 | 1 | 24.5 | 0.24 | 28.03 | 20.03 |
| SLC23 | 57 | 2 | 1 | 25.0 | 0.25 | 27.78 | 33.65 |
| SLC3 | 9 | 2 | 1 | 26.2 | 0.26 | 20.76 | 25.81 |
| SLC15 | 45 | 2 | 1 | 26.2 | 0.26 | 22.6 | |
| SLC27 | 65 | 2 | 1 | 26.9 | 0.27 | 31.39 | 27.58 |
| SLC16 | 48 | 2 | 2 | 13.7 | 0.27 | 29.78 | 36.6 |
| SLCA8 | 7 | 2 | 1.5 | 19.0 | 0.29 | 27.75 | 24.39 |
| SLCA8 | 8 | 2 | 1.5 | 19.0 | 0.29 | 32.11 | 28.47 |
| SLCA8 | 14 | 2 | 1.5 | 19.0 | 0.29 | 27.75 | 20.29 |
| SLC14 | 44 | 2 | 2 | 14.3 | 0.29 | 30.89 | 37.34 |
| SLC31 | 73 | 2 | 1.5 | 19.9 | 0.30 | 32.93 | 44.4 |
| SLC35 | 84 | 2 | 2 | 15.6 | 0.31 | 27.63 | 29.92 |
| SLC25 | 61 | 2 | 1 | 31.2 | 0.31 | 25.42 | 29.02 |
| SLC30 | 69 | 2 | 1.5 | 21.2 | 0.32 | 38.22 | 41.71 |
| SLC22 | 55 | 2 | 1 | 32.0 | 0.32 | 32 | 40.79 |
| SLC7 | 30 | 1.5 | 1.5 | 22.0 | 0.33 | 27.75 | 31.5 |
| SLC8 | 32 | 1.5 | 1.5 | 22.0 | 0.33 | 25.07 | 30.49 |
| SLC33 | 77 | 2 | 1.5 | 22.6 | 0.34 | 33.42 | 31.83 |
| SLC17 | 50 | 2 | 2 | 18.1 | 0.36 | 38.57 | |
| SLC4 | 12 | 2 | 1.5 | 24.3 | 0.36 | 26.99 | 32.61 |
| SLC5 | 24 | 2 | 1.5 | 24.3 | 0.36 | 48.93 | 42.4 |
| SLC6 | 26 | 2 | 1.5 | 24.3 | 0.36 | 43.19 | 45.5 |
| SLC6 | 28 | 2 | 1.5 | 24.3 | 0.36 | 37.74 | 37.37 |
| SLC10 | 71 | 2 | 1.5 | 24.3 | 0.36 | 33.77 | 35.52 |
| SLC32 | 75 | 2 | 1.5 | 25.1 | 0.38 | 37.47 | 39.62 |
| SLCA8 | 15 | 1 | 2 | 19.0 | 0.38 | 20.07 | 27.1 |
| SLCA8 | 16 | 2 | 2 | 19.0 | 0.38 | 32.24 | 39.32 |
| SLCA8 | 17 | 1 | 2 | 19.0 | 0.38 | 18.33 | 22.95 |
| SLCA8 | 18 | 2 | 2 | 19.0 | 0.38 | 26.73 | 33.54 |
| SLC29 | 68 | 2 | 2.3 | 16.8 | 0.39 | 35.68 | 31.52 |
| SLC3 | 10 | 2 | 1.5 | 26.2 | 0.39 | 24.88 | 27.4 |
| SLC24 | 60 | 2 | 2 | 19.7 | 0.39 | 31.29 | 35.96 |
| SLC31 | 74 | 2 | 2 | 19.9 | 0.40 | 37.72 | 38.92 |
| SLC37 | 88 | 2 | 2 | 20.0 | 0.40 | 32.43 | 33.97 |
| SLC20 | 53 | 2 | 2 | 20.0 | 0.40 | 30.32 | 34.62 |
| SLC19 | 52 | 2 | 2 | 21.0 | 0.42 | 27.83 | |
| SLC9 | 34 | 1.5 | 2 | 22.0 | 0.44 | 24.28 | 21.24 |
| SLC21 | 54 | 2 | 2 | 22.2 | 0.44 | 29.8 | 27.65 |
| SLC33 | 78 | 2 | 2 | 22.6 | 0.45 | 33.68 | 34.52 |
| SLC26 | 64 | 2 | 2 | 22.6 | 0.45 | 38.6 | 28.4 |
| SLC12 | 38 | 1.5 | 2 | 23.2 | 0.46 | 25.9 | 27.36 |
| SLC13 | 40 | 1.5 | 2 | 23.2 | 0.46 | 30.37 | 29.48 |
| SLC4 | 20 | 1.5 | 2 | 24.3 | 0.49 | 38.21 | 52.77 |
| SLC4 | 22 | 1.5 | 2 | 24.3 | 0.49 | 35.82 | 51.19 |
| SLC5 | 23 | 1 | 2 | 24.3 | 0.49 | 38.27 | 34.54 |
| SLC6 | 25 | 1.5 | 2 | 24.3 | 0.49 | 38.29 | 41.7 |
| SLC11 | 36 | 1.5 | 2 | 24.3 | 0.49 | 34.31 | 35.15 |
| SLC10 | 42 | 2 | 2 | 24.3 | 0.49 | 40.23 | 37.36 |
| SLC10 | 72 | 2 | 2 | 24.3 | 0.49 | 36.46 | 36.98 |
| SLC10 | 82 | 2 | 2 | 24.3 | 0.49 | 22.35 | 36.98 |
| SLC36 | 86 | 2 | 2 | 24.5 | 0.49 | 28.18 | 33.2 |
| SLC23 | 58 | 2 | 2 | 25.0 | 0.50 | 26.72 | 37.22 |
| SLC34 | 79 | 2 | 1 | 50.0 | 0.50 | 22.66 | 19.94 |
| SLC32 | 76 | 2 | 2 | 25.2 | 0.50 | 38.48 | 42.69 |
| SLC28 | 67 | 2 | 2.3 | 22.6 | 0.52 | 24.58 | 25.97 |
| SLC3 | 19 | 1.5 | 2 | 26.2 | 0.52 | 30.68 | 40.93 |
| SLC3 | 21 | 1.5 | 2 | 26.2 | 0.52 | 32.32 | 44.36 |
| SLC15 | 46 | 2 | 2 | 26.2 | 0.52 | 28.6 | |
| SLC27 | 66 | 2 | 2 | 26.9 | 0.54 | 27.77 | 39.7 |
| SLC25 | 62 | 2 | 2 | 31.2 | 0.62 | 27.69 | 28.04 |
| SLC30 | 70 | 2 | 3 | 21.2 | 0.64 | 37.07 | 48.44 |
| SLC22 | 56 | 2 | 2 | 32.0 | 0.64 | 32.39 | 39.93 |
| SLC34 | 80 | 2 | 2 | 50.0 | 1.00 | 25.33 | 21.59 |
| SLC34 | 81 | 2 | 2 | 50.0 | 1.00 | 28.41 | 36.64 |

Table 6 tabulated the range of cure-set phr in dry condition and the number of experiments carried out in that range.

TABLE 6
Cure-set phr versus number of experiments
carried out in respective phr

| Cure phr Dry | No expt. | Cum. Expt. |
|---|---|---|
| ≤0.15 | 4 | 4 |
| ≤0.20 | 8 | 12 |
| ≤0.25 | 14 | 26 |
| ≤0.30 | 11 | 37 |
| ≤0.40 | 24 | 61 |
| ≤0.50 | 19 | 80 |
| ≤0.70 | 6 | 86 |
| ≤1.0 | 2 | 88 |

Set SLC34 was the conventionally prepared cure-set, it was used in experiments 79, 80 and 81 at 0.5 phr (dry basis) and 1.0 phr (dry basis) respectively.

SLC2 used in experiment 3 at the tune of 0.11 dry phr could match the 0.5 phr dry level of SLC34 (experiment 79) on the film strength.

SLC16 and 14 used in experiments 47 and 43 respectively at 0.14 phr could match the 1.0 phr dry of SLC 34 (experiment 80) on the film strength.

SLC14 and SLC16 used in experiments 44 and 48 respectively at 0.29 phr and 0.27 phr could match the 1.0 phr dry metal used SLC34 (experiment 81) on the film strength. In fact experiment 81 with SLC34 used additional 2 dry phr curatives in the form of sulphur and sulphur donor whereas experiment 44 and 48 did not use any additional covalent curatives.

In some experiments like 20 and 22, SLC4 was used resulting very high tensile strength of dipped article at the dry phr of 0.49.

### CONCLUSION

In view of the above-said comparative study and results obtained, it could be inferred that the present method of making dispersion gives better film strength at lower consumption of curative polyvalent metal ions.

The heterogeneous composite chemical curative dispersion prepared via the present invention is capable of producing an elastomeric article that has wide range of flexing level. More particularly, the relative movement of the molecules in the three-dimensional array of elastomeric article is very high compared to the rigid solid materials like metal or ceramic or plastic materials. Dispersion formed via the present invention possess stability upon storage for a period of 3 to 6 months.

The advantage of heterogenous state with multiple phases gives field of equilibrium between the active molecules and the activators under the environment of surfactants and stabilizers. Moreover, the final reaction with anionic polymeric emulsion will be in heterogenous state, such high molecular organic polymeric molecules are water insoluble and contains various functional groups depending on the end product selection.

The exemplary implementation described above is illustrated with specific characteristics, but the scope of the invention includes various other characteristics.

Various modifications to these embodiments are apparent to those skilled in the art from the description and the accompanying drawings. The principles associated with the various embodiments described herein may be applied to other embodiments. Therefore, the description is not intended to be limited to the embodiments shown along with the accompanying drawings but is to be providing broadest scope of consistent with the principles and the novel and inventive features disclosed or suggested herein. Accordingly, the invention is anticipated to hold on to all other such alternatives, modifications, and variations that fall within the scope of the present invention and appended claim.

It is to be understood that any prior art publication referred to herein does not constitute an admission that the publication forms part of the common general knowledge in the art.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A method (100) of preparing a heterogeneous composite chemical curative dispersion for making elastomeric article, the method comprising the steps of:
preparing a metal composite (10);
adding alkaline solution in said metal composite to form a mixture (20);
pulverizing said mixture (30); and
adjusting total solid content in said mixture (60);
characterized in that prior to adjusting the total solid content,
subjecting the pulverized mixture to excessive hydroxyl ion and heat above 100° C. to obtain the mixture in a paste form (40), whereby said step activates and enhances reactivity at ionic and atomic level of the mixture;
mixing stabilizer, surfactant and water into said mixture to form said heterogenous composite chemical curative dispersion (50).

2. The method (100) as claimed in claim 1, wherein repeating the pulverizing step if the mixture obtained after subjecting to excessive hydroxyl ion and heat is in powder form.

3. The method (100) as claimed in claim 1, wherein said mixture is pulverized with an average particle size of diameter less than 5 microns for at least 95% of the total number of particles.

4. The method (100) as claimed in claim 3, wherein the remaining 5% of the total number of particles is pulverized with an average particle size of diameter less than 15 microns.

5. The method (100) as claimed in claim 1, wherein the metal composite comprising a monovalent metal selected from alkali metal comprising lithium, sodium or potassium.

6. The method (100) as claimed in claim 1, wherein the metal composite comprising a polyvalent metal selected from alkaline earth metal, transition metal or post transition metal including magnesium, iron, copper, zinc or aluminium.

7. The method (100) as claimed in claim 1, wherein the metal composite comprising a polyvalent metal in the form of oxides or hydroxides.

8. The method (100) as claimed in claim 1, wherein the alkaline solution is added with surfactant and water in said polyvalent metal to form the mixture.

9. The method (100) as claimed in claim 1, wherein the mixture is pulverized under alkaline condition above pH 10 with anionic or non-ionic wetting agent.

10. The method (100) as claimed in claim 1, wherein the metal composite comprising a polyvalent metal salt.

11. The method (100) as claimed in claim 1, wherein the mixture is pulverized with surfactant and alkaline solution.

12. The method (100) as claimed in claim 1, wherein adding alkaline solution in said metal composite to form the mixture further comprising the steps of:
adding the alkaline solution in said metal composite; and
mixing the mixture until a pH above 12 to 14;
whereby a supernatant containing a soluble salt is formed.

13. The method (100) as claimed in claim 12, wherein the supernatant formed from said mixing is decanted.

14. The method (100) as claimed in claim 1, wherein the stabilizer, surfactant and water are mixed with addition of sulphur and sulphur donor into said mixture.

15. The method (100) as claimed in claim 1, wherein the heterogenous composite chemical curative dispersion comprising 5% to 40% by weight of hydroxides of the alkaline solution.

16. The method (100) as claimed in claim 1, wherein the heterogenous composite chemical curative dispersion comprising 25% to 250% by weight of hydroxides of the alkaline solution with respect to the metal composite.

17. The method (100) as claimed in claim 1, wherein the heterogenous composite chemical curative dispersion comprising 25% to 400% by weight of hydroxides of the alkaline solution with respect to the metal composite in the form of oxides.
